(19) United States
(12) Patent Application Publication
(10) Pub. No.: US 2026/0209446 A1
(43) Pub. Date: Jul. 23, 2026

(54) Vitrimer of Cyclopentene-Based Ring-Opening Polyolefin

(71) Applicant: ExxonMobil Technology and Engineering Company, Baytown, TX (US)

(72) Inventors: Carlos R. Lopez-Barron, Houston, TX (US); Alexander V. Zabula, Seabrook, TX (US); Jiemin Lu, Manvel, TX (US)

(21) Appl. No.: 19/144,000

(22) PCT Filed: Dec. 19, 2023
(86) PCT No.: PCT/US2023/084757

§ 371 Date: Jun. 27, 2025

Related U.S. Application Data
(60) Provisional application No. 63/478,284, filed on Jan. 3, 2023.

(51) Int. Cl. C08G 79/08

(52) U.S. Cl. CPC C08G 79/08; C08G 2261/332; C08G 2261/418

(57) ABSTRACT

This disclosure relates generally to a vitrimer of cyclopentene-based ring-opening polyolefin, to a process for preparing the vitrimer, to a compound (1) as the crosslinker, to a process for preparing compound (1), to a vulcanized vitrimer, to a composition comprising the vitrimer or the vulcanized vitrimer and to an article comprising the vitrimer or the vulcanized vitrimer.

### CROSS-REFERENCE TO RELATED APPLICATION

The present application claims priority to and the benefit of U.S. Provisional Application No. 63/478,284 filed on 3 Jan. 2023, which is hereby incorporated by reference in its entirety.

### FIELD OF THE INVENTION

This disclosure relates generally to a vitrimer of cyclopentene-based ring-opening polyolefin, to a process for preparing the vitrimer, to a compound (1) as the crosslinker, to a process for preparing compound (1), to a vulcanized vitrimer, to a composition comprising the vitrimer or the vulcanized vitrimer and to an article comprising the vitrimer or the vulcanized vitrimer.

### BACKGROUND OF THE INVENTION

Conventional rubber vulcanization processes involve crosslink reactions that generate irreversible covalent bonds between all the polymer chains in the sample.

Vitrimers are a new class of polymeric materials displaying dynamically crosslinked networks. The topology of such networks is not fixed, as the bonds connecting the different polymer chains undergo associative exchange reactions that allows them to “dissociate” from a given location and “re-associate” in a different location in the network.

These exchange reactions are activated at temperatures above the topological freezing transition temperature (Tv). Below Tv, vitrimers behave as solid elastic networks (i.e., as thermosets or vulcanized elastomers), and above Tv, they behave as viscoelastic liquids (i.e., as melts).

### SUMMARY OF THE INVENTION

In a first general aspect, this disclosure provides a vitrimer of cyclopentene-based ring-opening polyolefin, wherein the cyclopentene-based ring-opening polyolefin is crosslinked with a compound (1), wherein compound (1) contains at least one reversible borate moiety or derivative thereof and at least two cyclic olefin groups; and there is a reversible borate moiety or derivative thereof between any two cyclic olefin groups in compound (1); wherein the derivative of borate moiety represents a moiety with the oxygen in the borate moiety being replaced with other element of the sixth main group, for example sulfur.

In a second general aspect, this disclosure provides a process of preparing the vitrimer of this disclosure, which comprises polymerizing cyclopentene, compound (1) of this disclosure and optional comonomer via ring-opening metathesis polymerization to form the vitrimer in one step.

In a third general aspect, this disclosure provides compound (1), wherein compound (1) contains at least one reversible borate moiety or derivative thereof and at least two cyclic olefin groups; and there is a reversible borate moiety or derivative thereof between any two cyclic olefin groups in compound (1); wherein the derivative of borate moiety represents a moiety with the oxygen in the borate moiety being replaced with other element of the sixth main group, for example sulfur.

In a fourth general aspect, this disclosure provides a process of preparing compound (1) of this disclosure comprising:
(i) reacting a B-containing compound with a polyol-type compound to form a compound containing at least one reversible borate moiety or derivative thereof and one hydroxyl;
(ii) reacting the compound containing at least one reversible borate moiety or derivative thereof and one hydroxyl obtained in step (i) with a compound containing a carboxyl and a cyclic olefin group to form compound (1),
wherein the B-containing compound is selected from a compound having a structure of B(QR)₃ and a compound having at least two B(QR)₂ groups, wherein R is selected from H or C₁-C₆-alkyl and each Q is independently an element of the sixth main group, or oxygen or sulfur; and
wherein the polyol-type compound has three hydroxyls and two of them are capable of forming the reversible borate moiety or derivative thereof with the B-containing compound, or the polyol-type compound has one hydroxyl and one ethylene oxide ring or oxetane ring.

In a fifth general aspect, this disclosure provides a vulcanized vitrimer, which is formed by vulcanizing the vitrimer of this disclosure.

In a sixth general aspect, this disclosure provides a composition comprising the vitrimer of this disclosure or the vulcanized vitrimer of this disclosure and at least one additive.

In a seventh general aspect, this disclosure provides an article comprising the vitrimer of this disclosure, the vulcanized vitrimer of this disclosure or the composition of this disclosure.

Certain aspects of the first, second, third, fourth, fifth, sixth and seventh general aspects may include one or more of the following features.

In some aspects, the reversible borate moiety or derivative thereof has a structure of Formula (I):

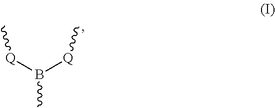

wherein each Q is independently an element of the sixth main group, preferably oxygen or sulfur, more preferably oxygen.

In some aspects, the -Q-B-Q- moiety in Formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring to form a fused ring system; or two borate moieties can share one B atom and form a spiro ring.

In some aspects, the boron-containing ring has the following structure:

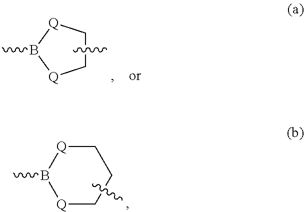

the fused ring system containing the boron-containing ring has the following structure:

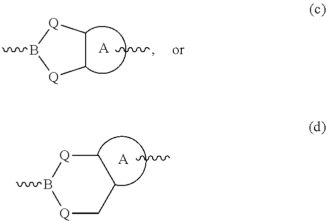

or two borate moieties can share one B atom and form a spiro ring; wherein A is a ring having 5 to 10 ring members, and wherein each Q is independently an element of the sixth main group, preferably oxygen or sulfur, more preferably oxygen.

In some aspects, compound (1) contains 1 to 3 reversible borate moieties or derivative thereof and 2 to 4 cyclic olefin groups; or compound (1) contains 1 or 2 reversible borate moieties or derivative thereof and 2 or 3 cyclic olefin groups.

In some aspects, compound (1) is selected from at least one compound having following structure:

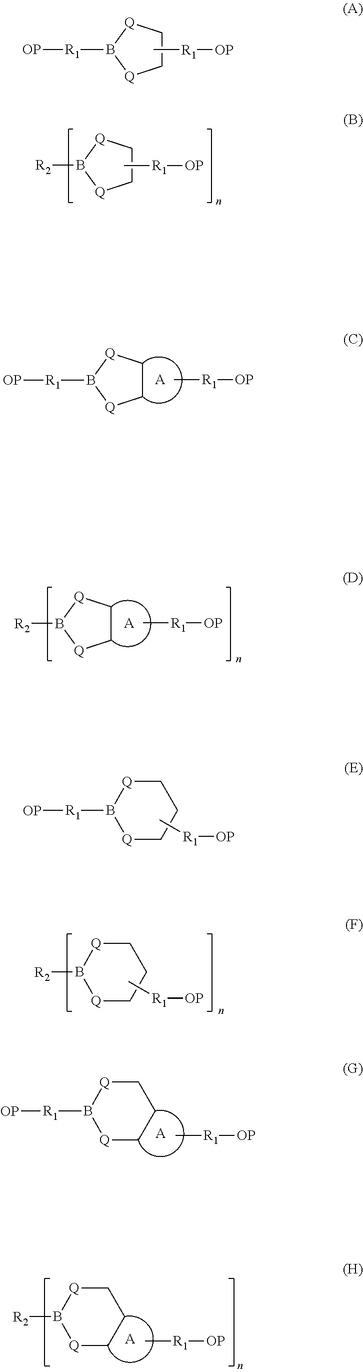

wherein:
   each R₁ is independently a direct bond or a divalent organic group having 1 to 20 carbon atoms;
each R₂ is independently a direct bond or an organic group having 1 to 20 carbon atoms;
or two borate moieties can share one B atom and form a spiro ring;
OP is a cyclic olefin group;
each A is independently a ring having 5 to 10 ring members;
each Q is independently an element of the sixth main group, or oxygen or sulfur; and
n is 2, 3 or 4.

In some aspects, the variables in the compounds of formulae (A) to (H) have the following definitions:
each R₁ is independently a direct bond or a divalent hydrocarbyl having 1 to 12 carbon atoms, which can optionally be interrupted by one or more nonadjacent oxygen atoms, and/or one or more nonadjacent carbon atoms in the divalent hydrocarbyl can optionally be replaced with —(CO)—O— and/or CO;
each R₂ is independently a direct bond or a linear or branched hydrocarbyl having 1 to 12 carbon atoms; or C₄-C₈-cycloalkyl, C₅-C₁₀-cycloalkenyl, C₆-C₁₀ aryl, C₁-C₁₂ alkyl-C₆-C₁₀ aryl, C₆-C₁₀ aryl-C₆-C₁₀ aryl, C₆-C₁₀ aryl-C₁-C₁₂ alkylene-C₆-C₁₀ aryl, C₄-C₁₀ heterocycloalkyl, C₄-C₁₀ heterocycloalkenyl, C₄-C₁₀ hetaryl or C₄-C₁₀ hetaryl-C₄-C₁₀ hetaryl, wherein the hydrocarbyl and the C₁-C₁₂ alkylene can optionally be interrupted by one or more nonadjacent oxygen atoms, and/or one or more nonadjacent carbon atoms in the hydrocarbyl and the C₁-C₁₂ alkylene can optionally be replaced with —(CO)—O— and/or CO and wherein the heterocycloalkyl, heterocycloalkenyl and hetaryl contain 1 to 3 heteroatoms selected from N, O, and S; and wherein the valence of R₂ corresponds to the value of n; or two borate moieties can share one B atom and form a spiro ring;
OP is a cyclic olefin group;
each A is independently a ring having 5 or 6 ring members;
each Q is oxygen; and
n is 2 or 3.

In some aspects, each R₁ is independently a direct bond or C₁-C₁₂ alkylene, which can optionally be interrupted by one or more nonadjacent oxygen atoms, and/or one or more nonadjacent carbon atoms in the C₁-C₁₂ alkylene can optionally be replaced with —(CO)—O— and/or CO; and
each R₂ is independently a direct bond, divalent or trivalent C₁-C₁₂ alkyl, divalent or trivalent C₄-C₈-cycloalkyl, divalent or trivalent C₅-C₁₀-cycloalkenyl, divalent or trivalent C₆-C₁₀ aryl, divalent or trivalent C₁-C₁₂ alkyl-C₆-C₁₀ aryl, divalent or trivalent C₆-C₁₀ aryl-C₆-C₁₀ aryl, divalent or trivalent C₆-C₁₀ aryl-C₁-C₁₂ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 heteroatoms selected from N, O, and S, wherein the divalent or trivalent C₁-C₁₂ alkyl and C₁-C₁₂ alkylene can optionally be interrupted by one or more nonadjacent oxygen atoms, and/or one or more nonadjacent carbon atoms in the divalent or trivalent C₁-C₁₂ alkyl and the C₁-C₁₂ alkylene can optionally be replaced with —(CO)—O— and/or CO.

In some aspects, the cyclic olefin group in the compound (1) is selected from 1-hydroxy-4-cyclooctene, 1-acetoxy-4-cyclooctene, cyclopentene, 5-methylcyclopentene, dicyclopentadiene (DCPD), norbornene, norbornadiene, cycloheptene, cyclooctene, cyclooctadiene, cyclododecene, 7-oxanorbornene, 7-oxanorbornadiene, cis-5-norbornene-endo-2,3-dicarboxylic anhydride, dimethyl norbornene carboxylate, and norbornene-exo-2,3-carboxylic anhydride groups, preferably cyclopentene group.

In some aspects, compound (1) is (1,4-phenylenebis(1,3,2-dioxaborolane-2,4-diyl))bis(butane-4,1-diyl)bis(cyclopent-3-ene-1-carboxylate).

In some aspects, the molar amount of the moiety derived from compound (1) is in the range from about 0.5 mol % to about 15 mol %, or from about 0.6 mol % to about 10 mol %, based on the total molar amount of the repeat unit of the cyclopentene-based ring-opening polyolefin.

In some aspects, the vitrimer is formed from cyclopentene and compound (1), or the vitrimer is formed from cyclopentene, compound (1) and other comonomer.

In some aspects, the tensile stress at 1000% strain of the vitrimer is at least 30 times, or at least 40 times that of the neat cyclopentene-based ring-opening polyolefin.

In some aspects, the elastic modulus of the vitrimer is at least about 180% or at least about 250% of the elastic modulus of the neat cyclopentene-based ring-opening polyolefin, at 150° C. tested by dynamic thermal-mechanical analysis at a heating rate of 2° C./min.

The vitrimer can be prepared by copolymerizing cyclopentene and optionally other cyclic monomers and compound (1) via cyclopentene ring-opening metathesis polymerization (ROMP) in one step and show enhanced properties including high tensile strength and high use temperature etc. Moreover, the incorporation of cyclopentene units into the polymer chain unlocks the opportunity for ideal circularity because they can be easily converted under mild conditions in the presence of ring closing metathesis catalyst back to monomers with high yield and high selectivity.

These and other features and attributes of the disclosed vitrimer of the present disclosure and their advantageous applications and/or uses will be apparent from the detailed description which follows.

### DESCRIPTION OF THE DRAWING

FIG. 1 shows dynamic mechanical temperature runs of CPR homopolymer and the vitrimers CPR-V1 and CPR-V2. Temperature ramps were performed at a heating rate of 2° C./min.

FIG. 2 shows dynamic frequency sweeps of CPR homopolymer and the vitrimers CPR-V1 and CPR-V2.

FIG. 3 shows tensile response of CPR homopolymer and the vitrimers CPR-V1 and CPR-V2, (a) Data for uncured samples, (b) Data for vulcanized samples with sulfur.

FIG. 4 shows cure kinetics curves of CPR homopolymer and the vitrimers CPR-V1 and CPR-V2 measured at 150° C.

### DETAILED DESCRIPTION OF THE INVENTION

Various specific embodiments, versions, and examples are described herein; including exemplary embodiments and definitions that are adopted for purposes of understanding the claimed invention. While the following detailed description gives specific preferred embodiments, those skilled in the art will appreciate that these embodiments are exemplary only and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

All numerical values within the detailed description and the claims herein are modified by “about” the indicated value, and take into account experimental error and variations that would be expected by those skilled in the art.

In a first general aspect, this disclosure provides a vitrimer of cyclopentene-based ring-opening polyolefin, wherein the cyclopentene-based ring-opening polyolefin is crosslinked with a compound (1), wherein compound (1) contains at least one reversible borate moiety or derivative thereof and at least two cyclic olefin groups; and there is a reversible borate moiety or derivative thereof between any two cyclic olefin groups in compound (1); wherein the derivative of borate moiety represents a moiety with the oxygen in the borate moiety being replaced with other element of the sixth main group, for example sulfur.

In the present disclosure, the element of the sixth main group is preferably O or S, more preferably O. The “other element of the sixth main group” can be S.

According to this disclosure, the phrase “the oxygen in the borate moiety being replaced with other element of the sixth main group” means the oxygen in the borate moiety is replaced with an element of the sixth main group, which is different from oxygen, for example the oxygen in the borate moiety can be replaced with S.

In an embodiment, the derivative of borate moiety represents a moiety with the oxygen in the borate moiety being replaced with S.

According to this disclosure, there is no substituent on Q.

In an embodiment, two borate moieties can share one B atom and form a spiro ring.

In an embodiment, the reversible borate moiety or derivative thereof has a structure of Formula (I):

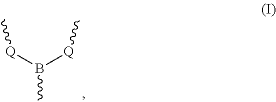

wherein each Q is independently an element of the sixth main group, preferably O or S, more preferably O.

In an embodiment, the -Q-B-Q- moiety in Formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring (for example the ring A as described below) to form a fused ring system, or two -Q-B-Q- moieties share one B atom and form a spiro ring.

In an embodiment, the boron-containing ring has the following structure:

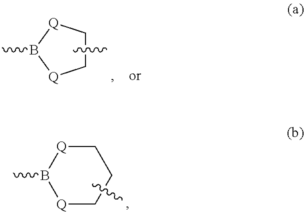

the fused ring system containing the boron-containing ring has the following structure:

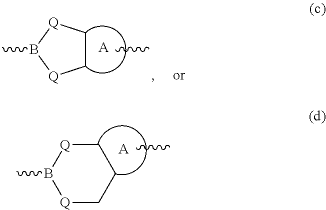

or two -Q-B-Q- moieties share one B atom and form a spiro ring; wherein A is a ring having 5 to 10 ring members and wherein each Q is independently an element of the sixth main group, preferably oxygen or sulfur.

According to this disclosure, the ring (A) fused with the boron-containing ring is a ring having 5 to 10 ring members, such as 5 to 8, or 5, 6, or 7 ring members. The ring (A) can be saturated, or partially unsaturated or aromatic carbo- or heterocyclic ring, which contains 1 to 4 (1, 2, 3, or 4), or 1 to 3 heteroatoms selected from N, O, and S, and wherein the aforementioned carbo- or heterocyclic rings system can be unsubstituted or substituted, wherein the substituents on the ring can join to form additional rings.

Examples of the heterocyclic rings as ring (A) include one of following:

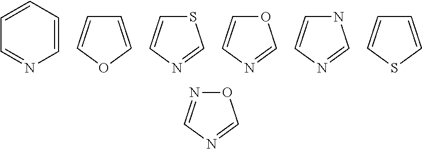

Examples of aromatic ring as ring (A) comprise phenyl ring or naphthalene ring.

In an embodiment, the fused ring system containing the boron-containing ring has the following structure:

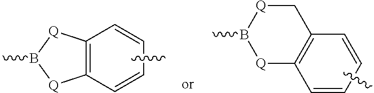

wherein each Q is independently an element of the sixth main group, preferably oxygen or sulfur.

In an embodiment, compound (1) contains at least two (for example 2 or 3) reversible borate moieties or derivative thereof. In an embodiment, compound (1) contains 1 to 3 (for example 1, 2 or 3) reversible borate moieties or derivative thereof and 2 to 4 (for example 2, 3 or 4) cyclic olefin groups. In an embodiment, compound (1) contains 1 to 3 (for example 1, 2 or 3) reversible borate moieties or derivative thereof and 2 cyclic olefin groups. In an embodiment, compound (1) contains 1 to 3 (for example 1, 2 or 3) reversible borate moieties or derivative thereof and 3 cyclic olefin groups. In an embodiment, compound (1) contains 1 or 2 reversible borate moieties or derivative thereof and 2 or 3 cyclic olefin groups. In an embodiment, compound (1) contains 1 or 2 reversible borate moieties or derivative thereof and 2 cyclic olefin groups. In an embodiment, compound (1) contains 2 reversible borate moieties or derivative thereof and 2 cyclic olefin groups. In an embodiment, compound (1) contains 2 reversible borate moieties and 2 cyclic olefin groups.

In an embodiment, compound (1) is selected from at least one compound having following structure:

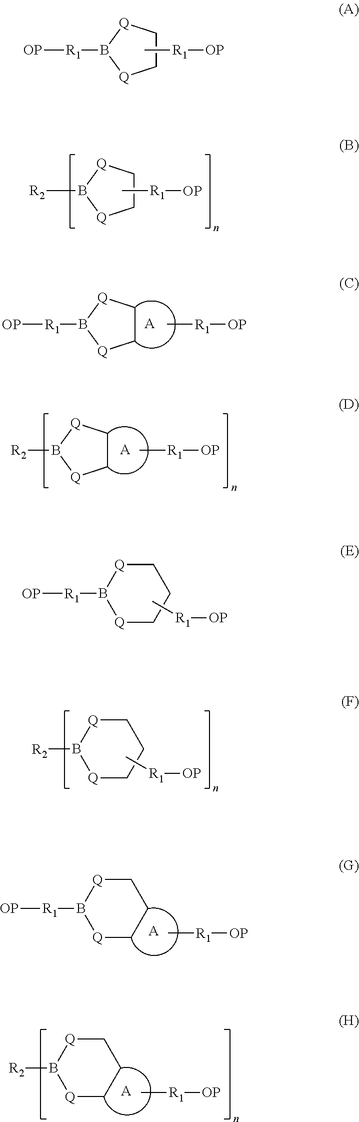

wherein
   each R₁ is independently a direct bond or a divalent organic group having 1 to 20 carbon atoms;
   each R₂ is independently a direct bond or an organic group having 1 to 20 carbon atoms; or two -Q-B-Q- moieties share one B atom and form a spiro ring;
   OP is a cyclic olefin group;
   each A is independently a ring having 5 to 10 ring members;
   each Q is independently an element of the sixth main group, or oxygen or sulfur; and
   n is 2, 3 or 4.

In an embodiment, each R₁ is independently a direct bond or a divalent hydrocarbyl having 1 to 12 carbon atoms (for example 1 to 6 carbon atoms, or 1 to 4 carbon atoms), which can optionally be interrupted by one or more nonadjacent oxygen atoms, and/or one or more nonadjacent carbon atoms in the divalent hydrocarbyl can optionally be replaced with —(CO)—O— and/or CO.

In an embodiment, each R₂ is independently a direct bond or a hydrocarbyl having 1 to 20 carbon atoms (for example 1, 2, 3, 4, 5, 6, 7, 8, 9, 10, 11, 12, 13, 14, 15, 16, 17, 18, 19 or 20, or 1 to 20, 1 to 16, 1 to 10, 1 to 12, 1 to 6, 2 to 20, 2 to 16, 2 to 12, 2 to 10, 2 to 6, 3 to 20, 3 to 16, 3 to 10, 3 to 12, 3 to 6, 4 to 20, 4 to 16, 4 to 10, 4 to 12, 4 to 6, 5 to 20, 5 to 16, 5 to 10, 5 to 12, 5 to 6, 6 to 20, 6 to 16, 6 to 10 carbon atoms), which can optionally be interrupted by one or more nonadjacent oxygen atoms, and/or one or more nonadjacent carbon atoms in the hydrocarbyl can optionally be replaced with —(CO)—O— and/or CO; and a 5-20-membered (for example 5, 6, 7, 8, 9, 10, 11, 12, 13, 14, 15, 16, 17, 18, 19, or 20, 5-18, 5-16, 5-12, or 5-10-membered) heterocyclic ring which contains 1 to 3 (for example 1, 2 or 3) heteroatoms selected from N, O, and S, or two -Q-B-Q- moieties share one B atom and form a spiro ring.

If two -Q-B-Q- moieties share one B atom and form a spiro ring, R₂ does not exist, and n is 2.

A person skilled in the art could understand that, the valence of R₂ corresponds to the value of n, for example if n is 2, valence of R₂ is 2; if n is 3, valence of R₂ is 3; if n is 4, valence of R₂ is 4.

The terms “hydrocarbyl radical,” “hydrocarbyl” and “hydrocarbyl group” are used interchangeably throughout this document unless otherwise specified. For purposes of this disclosure, a hydrocarbyl radical is defined to be C₁ to C₂₀ radicals (for example, C₁, C₂, C₃, C₄, C₅, C₆, C₈, C₁₀, C₁₂, C₁₆, C₁₈, or C₂₀) or C₁ to C₁₂ radicals, C₁ to C₆ radicals, C₂ to C₁₂ radicals, C₃ to C₁₂ radicals, or C₄ to C₁₂ radicals, or C₆ to C₂₀ radicals, C₆ to C₂₀ radicals, or C₇ to C₂₀ radicals or C₅ to C₁₀ radicals, or C₅ to C₁₀ radicals or C₆ to C₁₀ radicals that may be linear, branched, or cyclic where appropriate (aromatic or non-aromatic, such as saturated or unsaturated); and can further include hydrocarbyl radicals substituted with other hydrocarbyl radicals and/or one or more functional groups.

In an embodiment, each R₁ is independently a direct bond or C₁-C₁₂ alkylene, which can optionally be interrupted by one or more nonadjacent oxygen atoms, and/or one or more nonadjacent carbon atoms in the C₁-C₁₂ alkylene can optionally be replaced with —(CO)—O— and/or CO. In an embodiment, each R₁ is independently a direct bond or C₁-C₆ alkylene, which can optionally be interrupted by one or more nonadjacent oxygen atoms, and/or one or more nonadjacent carbon atoms in the C₁-C₆ alkylene can optionally be replaced with —(CO)—O— and/or CO. In an embodiment, R₁ is methylene or ethylene.

In some aspects, each R₁ is independently a R₁₁—(CO)—O—R₁₂, wherein R₁₁ is a direct bond or divalent hydrocarbyl (for example alkylene) having 1 to 12 or 1 to 6 or 1 to 4 carbon atoms, which can optionally be interrupted by one or more nonadjacent oxygen atoms, and/or one or more nonadjacent carbon atoms in the divalent hydrocarbyl (for example alkylene) can optionally be replaced with —(CO)—O— and/or CO; and

R₁₂ is a divalent hydrocarbyl (for example alkylene) having 1 to 12, or 1 to 6, or 1 to 4, or 2 to 12, or 2 to 6, or 3 to 12, or 3 to 6 carbon atoms, which can optionally be interrupted by one or more nonadjacent oxygen atoms, and/or one or more nonadjacent carbon atoms in the divalent hydrocarbyl (for example alkylene) can optionally be replaced with —(CO)—O— and/or CO, wherein R₁₁ is connected with cyclic olefin group (OP).

In an embodiment, each R₂ is independently a direct bond, a liner or branched C₁-C₂₀ hydrocarbyl, which can optionally be interrupted by one or more nonadjacent oxygen atoms, and/or one or more nonadjacent carbon atoms in the hydrocarbyl can optionally be replaced with —(CO)—O— and/or CO; a saturated, or partially unsaturated or aromatic carbo- or heterocyclic ring having 3 to 20 carbon atoms, which contains 1 to 3 (for example 1, 2, 3) heteroatoms selected from N, O, and S; or two -Q-B-Q- moieties share one B atom and form a spiro ring. The number of carbon atoms of the liner or branched hydrocarbyl and the number of carbon atoms of ring are as mentioned above for the organic groups.

In an embodiment, each R₂ is independently a direct bond or a liner or branched hydrocarbyl having 1 to 12 carbon atoms (for example 1 to 6 carbon atoms, or 1 to 4 carbon atoms, or 2 to 12, or 4 to 12, or 2 to 6, or 4 to 6, or 6 to 10 carbon atoms); C₄-C₈-cycloalkyl, C₅-C₁₀-cycloalkenyl, C₆-C₁₀ aryl, C₁-C₁₂ alkyl-C₆-C₁₀ aryl, C₆-C₁₀ aryl-C₆-C₁₀ aryl, C₆-C₁₀ aryl-C₁-C₁₂ alkylene-C₆-C₁₀ aryl, C₄-C₁₀ heterocycloalkyl, C₄-C₁₀ heterocycloalkenyl, C₄-C₁₀ hetaryl, C₄-C₁₀ hetaryl-C₄-C₁₀ hetaryl, wherein the hydrocarbyl and the C₁-C₁₂ alkylene can optionally be interrupted by one or more nonadjacent oxygen atoms, and/or one or more nonadjacent carbon atoms in the hydrocarbyl and the C₁-C₁₂ alkylene can optionally be replaced with —(CO)—O— and/or CO and wherein the heterocycloalkyl, heterocycloalkenyl and hetaryl contain 1 to 3 (for example 1, 2, 3) heteroatoms selected from N, O, and S; and wherein the valence of R₂ corresponds to the value of n.

In an embodiment, each R₂ is independently a direct bond, divalent or trivalent C₁-C₁₂ alkyl, divalent or trivalent C₄-C₈-cycloalkyl, divalent or trivalent C₅-C₁₀-cycloalkenyl, divalent or trivalent C₆-C₁₀ aryl, divalent or trivalent C₁-C₁₂ alkyl-C₆-C₁₀ aryl, divalent or trivalent C₆-C₁₀ aryl-C₆-C₁₀ aryl, divalent or trivalent C₆-C₁₀ aryl-C₁-C₁₂ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₁-C₁₂ alkyl and the C₁-C₁₂ alkylene can optionally be interrupted by one or more nonadjacent oxygen atoms, and/or one or more nonadjacent carbon atoms in the divalent or trivalent C₁-C₁₂ alkyl and the C₁-C₁₂ alkylene can optionally be replaced with —(CO)—O— and/or CO.

Taking divalent or trivalent C₁-C₁₂ alkyl-C₆-C₁₀ aryl as an example, it means the total valence of C₁-C₁₂ alkyl-C₆-C₁₀ aryl is divalence or trivalence.

In an embodiment, each R₂ is independently a direct bond, divalent or trivalent C₁-C₆ alkyl, or divalent or trivalent C₄-C₈-cycloalkyl, divalent or trivalent C₅-C₁₀-cycloalkenyl, divalent or trivalent C₆-C₁₀ aryl, divalent or trivalent C₁-C₆ alkyl-C₆-C₁₀ aryl, divalent or trivalent C₆-C₁₀ aryl-C₆-C₁₀ aryl, divalent or trivalent C₆-C₁₀ aryl-C₁-C₆ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₁-C₆ alkyl and the C₁-C₆ alkylene can optionally be interrupted by one or more nonadjacent oxygen atoms, and/or one or more nonadjacent carbon atoms in the divalent or trivalent C₁-C₆ alkyl and the C₁-C₆ alkylene can optionally be replaced with —(CO)—O— and/or CO.

In an embodiment, each R₂ is independently a direct bond, divalent or trivalent C₄-C₁₂ alkyl, or divalent or trivalent C₄-C₈-cycloalkyl, divalent or trivalent C₅-C₁₀-cycloalkenyl, divalent or trivalent C₆-C₁₀ aryl, divalent or trivalent C₁-C₆ alkyl-C₆-C₁₀ aryl, divalent or trivalent C₆-C₁₀ aryl-C₆-C₁₀ aryl, divalent or trivalent C₆-C₁₀ aryl-C₁-C₆ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₄-C₁₂ alkyl and the C₁-C₆ alkylene can optionally be interrupted by one or more nonadjacent oxygen atoms, and/or one or more nonadjacent carbon atoms in the divalent or trivalent C₄-C₁₂ alkyl and the C₁-C₆ alkylene can optionally be replaced with —(CO)—O— and/or CO.

In an embodiment, each R₂ is independently a direct bond, C₁-C₁₂ alkylene (i.e., divalent C₁-C₁₂ alkyl), or divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₁₂ alkylene-C₆-C₁₀ aryl, divalent C₄-C₁₀ heterocycloalkyl, divalent C₄-C₁₀ heterocycloalkenyl, divalent C₄-C₁₀ hetaryl, divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₁₂ alkylene can optionally be interrupted by one or more nonadjacent oxygen atoms, and/or one or more nonadjacent carbon atoms in the C₁-C₁₂ alkylene can optionally be replaced with —(CO)—O— and/or CO.

In an embodiment, each R₂ is independently a direct bond, C₄-C₁₂ alkylene (i.e., divalent C₄-C₁₂ alkyl), or divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₁₂ alkylene-C₆-C₁₀ aryl, divalent C₄-C₁₀ heterocycloalkyl, divalent C₄-C₁₀ heterocycloalkenyl, divalent C₄-C₁₀ hetaryl, divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₄-C₁₂ alkylene and the C₁-C₁₂ alkylene can optionally be interrupted by one or more nonadjacent oxygen atoms, and/or one or more nonadjacent carbon atoms in the C₄-C₁₂ alkylene and the C₁-C₁₂ alkylene can optionally be replaced with —(CO)—O— and/or CO.

In an embodiment, each R₂ is independently a direct bond, C₁-C₆ alkylene (i.e., divalent C₁-C₆ alkyl), or divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₆ alkylene-C₆-C₁₀ aryl, divalent C₄-C₁₀ heterocycloalkyl, divalent C₄-C₁₀ heterocycloalkenyl, divalent C₄-C₁₀ hetaryl or divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₆ alkylene can optionally be interrupted by one or more nonadjacent oxygen atoms, and/or one or more nonadjacent carbon atoms in the C₁-C₆ alkylene can optionally be replaced with —(CO)—O— and/or CO.

In an embodiment, each R₂ is independently a divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₆ alkylene-C₆-C₁₀ aryl, divalent C₄-C₁₀ heterocycloalkyl, divalent C₄-C₁₀ heterocycloalkenyl, divalent C₄-C₁₀ hetaryl or divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₆ alkylene can optionally be interrupted by one or more nonadjacent oxygen atoms, and/or one or more nonadjacent carbon atoms in the C₁-C₆ alkylene can optionally be replaced with —(CO)—O— and/or CO; preferably divalent C₆-C₁₀ aryl, divalent C₆-C₁₀ aryl-C₆-C₁₀ aryl, divalent C₄-C₁₀ hetaryl or divalent C₄-C₁₀ hetaryl-C₄-C₁₀ hetaryl, wherein the hetaryl contains 1 to 3 (for example 1, 2, 3) heteroatoms selected from N, O, and S.

In an embodiment, each R₂ is independently a phenylene, phenylene-phenylene, or divalent thiophene radical.

A is as defined above. In an embodiment, each A is independently a ring having 5 or 6 ring members.

In an embodiment, n is 2 or 3, for example 2, for example 3.

In an embodiment, Q is S or O, preferably O.

In an embodiment, the variables in the above Formulae (A), (B), (C), (D), (E), (F), (G) and (H) have the following definition:
each R₁ is independently a direct bond or a divalent hydrocarbyl having 1 to 12 carbon atoms, which can optionally be interrupted by one or more nonadjacent oxygen atoms, and/or one or more nonadjacent carbon atoms in the divalent hydrocarbyl can optionally be replaced with —(CO)—O— and/or CO;
each R₂ is independently a direct bond or a linear or branched hydrocarbyl having 1 to 12 carbon atoms; or C₄-C₈-cycloalkyl, C₅-C₁₀-cycloalkenyl, C₆-C₁₀ aryl, C₁-C₁₂ alkyl-C₆-C₁₀ aryl, C₆-C₁₀ aryl-C₆-C₁₀ aryl, C₆-C₁₀ aryl-C₁-C₁₂ alkylene-C₆-C₁₀ aryl, C₄-C₁₀ heterocycloalkyl, C₄-C₁₀ heterocycloalkenyl, C₄-C₁₀ hetaryl or C₄-C₁₀ hetaryl-C₄-C₁₀ hetaryl, wherein the hydrocarbyl and the C₁-C₁₂ alkylene can optionally be interrupted by one or more nonadjacent oxygen atoms, and/or one or more nonadjacent carbon atoms in the hydrocarbyl and the C₁-C₁₂ alkylene can optionally be replaced with —(CO)—O— and/or CO and wherein the heterocycloalkyl, heterocycloalkenyl and hetaryl contain 1 to 3 (for example 1, 2 or 3) heteroatoms selected from N, O, and S; and wherein the valence of R₂ corresponds to the value of n; or two -Q-B-Q- moieties share one B atom and form a spiro ring;
OP is a cyclic olefin group;
each A is independently a ring having 5 or 6 ring members;
each Q is oxygen; and
n is 2 or 3.

In an embodiment, the variables in the above Formulae (A), (B), (C), (D), (E), (F), (G) and (H) have the following definition:
each R₁ is independently a direct bond or C₁-C₁₂ alkylene, which can optionally be interrupted by one or more nonadjacent oxygen atoms, and/or one or more nonadjacent carbon atoms in the C₁-C₁₂ alkylene can optionally be replaced with —(CO)—O— and/or CO;
each R₂ is independently a direct bond, divalent or trivalent C₁-C₁₂ alkyl, divalent or trivalent C₄-C₈-cycloalkyl, divalent or trivalent C₅-C₁₀-cycloalkenyl, divalent or trivalent C₆-C₁₀ aryl, divalent or trivalent C₁-C₁₂ alkyl-C₆-C₁₀ aryl, divalent or trivalent C₆-C₁₀ aryl-C₆-C₁₀ aryl, divalent or trivalent C₆-C₁₀ aryl-C₁-C₁₂ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, or divalent or trivalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the divalent or trivalent C₁-C₁₂ alkyl and the C₁-C₁₂ alkylene can optionally be interrupted by one or more nonadjacent oxygen atoms, and/or one or more nonadjacent carbon atoms in the divalent or trivalent C₁-C₁₂ alkyl and the C₁-C₁₂ alkylene can optionally be replaced with —(CO)—O— and/or CO; or two -Q-B-Q- moieties share one B atom and form a spiro ring;
OP is a cyclic olefin group;
each A is independently a ring having 5 or 6 ring members;
each Q is oxygen; and
n is 2 or 3.

In an embodiment, the variables in the above Formulae (A), (B), (C), (D), (E), (F), (G) and (H) have the following definition:
each R₁ is independently a direct bond or C₁-C₆ alkylene, which can optionally be interrupted by one or more nonadjacent oxygen atoms, and/or one or more nonadjacent carbon atoms in the C₁-C₆ alkylene can optionally be replaced with —(CO)—O— and/or CO;
each R₂ is independently a direct bond, C₁-C₆ alkylene, divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₆ alkylene-C₆-C₁₀ aryl, divalent C₄-C₁₀ heterocycloalkyl, divalent C₄-C₁₀ heterocycloalkenyl, divalent C₄-C₁₀ hetaryl or divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₁-C₆ alkylene can optionally be interrupted by one or more nonadjacent oxygen atoms, and/or one or more nonadjacent carbon atoms in the C₁-C₆ alkylene can optionally be replaced with —(CO)—O— and/or CO; or two -Q-B-Q- moieties share one B atom and form a spiro ring; OP is a cyclic olefin group;
each A is independently a ring having 5 or 6 ring members;
each Q is oxygen; and
n is 2.

In an embodiment, the variables in the above Formulae (A), (B), (C), (D), (E), (F), (G) and (H) have the following definition:
each R₁ is independently a direct bond or C₁-C₆ alkylene, which can optionally be interrupted by one or more nonadjacent oxygen atoms, and/or one or more nonadjacent carbon atoms in the C₁-C₆ alkylene can optionally be replaced with —(CO)—O— and/or CO;
each R₂ is independently a C₄-C₁₂ alkylene, divalent C₄-C₈-cycloalkyl, divalent C₅-C₁₀-cycloalkenyl, divalent C₆-C₁₀ aryl, divalent C₁-C₆ alkyl-C₆-C₁₀ aryl, divalent C₆-C₁₀ aryl-C₆-C₁₀ aryl, divalent C₆-C₁₀ aryl-C₁-C₆ alkylene-C₆-C₁₀ aryl, divalent C₄-C₁₀ heterocycloalkyl, divalent C₄-C₁₀ heterocycloalkenyl, divalent C₄-C₁₀ hetaryl or divalent C₄-C₁₀ hetaryl-C₄-C₁₀ hetaryl, wherein the heterocycloalkyl, heterocycloalkenyl and hetaryl contain 1 to 3 (for example 1, 2, 3) heteroatoms selected from N, O, and S, wherein the C₄-C₁₂ alkylene and the C₁-C₆ alkylene can optionally be interrupted by one or more nonadjacent oxygen atoms, and/or one or more nonadjacent carbon atoms in the C₄-C₁₂ alkylene and the C₁-C₆ alkylene can optionally be replaced with —(CO)—O— and/or CO; or two -Q-B-Q- moieties share one B atom and form a spiro ring;
OP is a cyclic olefin group;
each A is independently a ring having 5 or 6 ring members;
each Q is oxygen; and
n is 2.

In an embodiment, each R₁ is independently C₁-C₆ alkylene, wherein one or more (for example 1, 2 or 3) nonadjacent carbon atoms in the C₁-C₆ alkylene is replaced with —(CO)—O— and/or CO.

In an embodiment, the cyclic olefin group (OP) is selected from 1-hydroxy-4-cyclooctene, 1-acetoxy-4-cyclooctene, cyclopentene, 5-methylcyclopentene, dicyclopentadiene (DCPD), norbornene, norbornadiene, cycloheptene, cyclooctene, cyclooctadiene (for example 1,5-cyclooctadiene), cyclododecene, 7-oxanorbornene, 7-oxanorbornadiene, cis-5-norbornene-endo-2,3-dicarboxylic anhydride, dimethyl norbornene carboxylate, and norbornene-exo-2,3-carboxylic anhydride groups, preferably cyclopentene group.

Specific examples of compound (1) can include, but not limited to, (1,4-phenylenebis(1,3,2-dioxaborolane-2,4-diyl))bis(butane-4,1-diyl)bis(cyclopent-3-ene-1-carboxylate).

In the vitrimer, the molar amount of the moiety derived from compound (1) is in the range from about 0.5 mol % to about 15 mol % (for example about 0.6 mol %, about 0.7 mol %, about 0.8 mol %, about 0.9 mol %, about 1 mol %, about 2 mol %, about 3 mol %, about 4 mol %, about 5 mol %, about 6 mol %, about 7 mol %, about 8 mol %, about 9 mol %, about 10 mol %, about 11 mol %, about 12 mol %, about 13 mol %, or about 14 mol %), or from about 0.6 mol % to about 10 mol %, or from about 0.6 mol % to about 8 mol %, or from about 1 mol % to about 8 mol %, or from about 1.5 mol % to about 6 mol %, based on the total molar amount of the repeat unit of the cyclopentene-based ring-opening polyolefin.

In this disclosure, the cyclopentene-based ring-opening polyolefin refers to a polymer comprises at least 50 wt % C₅ repeating unit derived from cyclopentene ring-opening metathesis polymerization (ROMP). In an embodiment, the cyclopentene-based ring-opening polyolefin comprises at least 50 wt %, at least 60 wt %, at least 70 wt %, at least 80 wt %, at least 90 wt %, or at least 95 wt % C₅ repeating unit derived from cyclopentene ring-opening metathesis polymerization (ROMP).

In this disclosure, polypentenamer means a polymer derived from cyclopentene ring-opening metathesis polymerization (ROMP).

In an embodiment, the vitrimer of this disclosure is formed from cyclopentene and compound (1), or the vitrimer is formed from cyclopentene, compound (1) and other comonomer. As mentioned below, the vitrimer is prepared by ring-opening metathesis polymerization in one step.

Suitable comonomer can comprises 1-hydroxy-4-cyclooctene, 1-acetoxy-4-cyclooctene, 5-methylcyclopentene, dicyclopentadiene (DCPD), norbornene, norbornadiene, cycloheptene, cyclooctene, cyclooctadiene (for example 1,5-cyclooctadiene), cyclododecene, 7-oxanorbornene, 7-oxanorbornadiene, cis-5-norbornene-endo-2,3-dicarboxylic anhydride, dimethyl norbornene carboxylate, and norbornene-exo-2,3-carboxylic anhydride.

In the vitrimer of this disclosure, the weight amount of the unit derived from the commoner ring-opening metathesis polymerization is not higher than the weight amount of the C₅ repeating unit derived from cyclopentene ring-opening metathesis polymerization.

As used herein, Mn is number average molecular weight, Mw is weight average molecular weight. Polydispersity index (PDI) is the value of Mw divided by Mn.

The vitrimer of this disclosure may have a weight average molecular weight (Mw) of about 10 to about 1000 kDa (for example 20, 50, 80, 100, 150, 200, 300, 350, 400, 500, 600, 800 or 900 kDa), or about 20 to about 800 kDa, or about 50 to about 800 kDa, or about 80 to about 800 kDa, or about 100 to about 600 kDa.

The vitrimer of this disclosure may have a PDI of from about 1.5 to about 4 (for example 1.6, 1.8, 2, 2.5, 3, 3.5 or 4), or from about 1.6 to about 3.5, or from about 1.6 to about 3.

In the vitrimer of this disclosure, each pentene repeating unit (C₅ repeating unit) may have a cis or trans configuration. The terms “cis” as used herein refers to the cis configuration of carbon-carbon double bonds of a polymer backbone. The terms “trans” as used herein refers to the trans configuration of carbon-carbon double bonds of a polymer backbone. The molar ratio of cis to trans can be in the range from about 5:95 to about 40:60, or from about 10:90 to about 30:70, or from about 15:85 to about 25:75.

The vitrimer of this disclosure has enhanced properties including high tensile stress, high use temperature etc.

The specimens for tensile and hysteresis tests are dog bone-shaped specimens (0.3 mm×2 mm×7 mm). For example, the specimens can be prepared by compression molding in a hot press preheated at 80° C. Tensile and hysteresis tests can be performed by uniaxially stretching at 25° C. and with a linear deformation rate of 100 microns/s. The instrument can be a solid analyzed instrument (RSA-G2, TA Instruments).

In an embodiment, the tensile stress at 1000% strain of the vitrimer is at least 30 times, at least 40 times, at least 50 times, at least 80 times, at least 100 times, at least 150 times, at least 200 times, at least 250 times, at least 300 times, or at least 350 times that of the neat cyclopentene-based ring-opening polyolefin. In an embodiment, the tensile stress at 1000% strain of the vitrimer is 30 to 600 times, or 40 to 550 times, 50 to 500 times, 80 to 500 times, 100 to 450 times, 150 to 400 times, 200 to 350 times, or 250 to 350 times that of the neat cyclopentene-based ring-opening polyolefin.

The elastic modulus of the vitrimer is at least about 180%, at least about 200%, at least about 250%, at least about 300%, at least about 350%, at least about 400%, at least about 450%, at least about 500%, or at least about 550%, or at least about 600%, or at least about 700% of the elastic modulus of the neat cyclopentene-based ring-opening polyolefin, at 150° C. tested by dynamic thermal-mechanical analysis at a heating rate of 2° C./min. In an embodiment, the elastic modulus of the vitrimer is about 180% to about 1200%, or about 200% to about 1000%, or about 250% to about 800%, or about 300% to about 800%, or about 350% to about 800%, or about 400% to about 700% of the elastic modulus of the neat cyclopentene-based ring-opening polyolefin, at 150° C. tested by dynamic thermal-mechanical analysis at a heating rate of 2° C./min.

In an embodiment, the complex viscosity of the vitrimer is at least 1, or at least 1.2, or at least 1.5, or at least 1.8, or at least 2 orders of magnitude larger than that of the neat cyclopentene-based ring-opening polyolefin, tested via dynamic frequency sweeps at 120° C. and at a frequency of 10⁻³ rad/s. In an embodiment, the viscosity of vitrimer tested at 120° C. and at a frequency of 10⁻³ rad/s is from 1 to 4.5, or from 1.2 to 4, or from 1.5 to 3.5, or from 1.5 to 3 orders of magnitude larger than that of the neat cyclopentene-based ring-opening polyolefin, tested via dynamic frequency sweeps at 120° C. and at a frequency of 10⁻³ rad/s.

The vitrimer of this disclosure shows high zero-shear viscosity (for example at a frequency of 10⁻³ rad/s), and low high-shear viscosity (for example at a frequency of 102.5 rad/s).

Unlike traditional crosslinked material, the vitrimer of this disclosure could be remold and reprocess.

The vitrimer of this disclosure has thermoplastic property, preferably is able to be processed by pressing, injection molding, extrusion molding, blow molding, calendering, foaming, solvent plasticizing, mold pressing, casting, reaction molding, for example by granulation and further hot press or extrusion. By “thermoplastic polymer(s)” is meant a polymer that can be melted by heat and then cooled without appreciable change in solid-state properties before and after heating.

In an embodiment, the vitrimer is reprocessed by physical means. For example, the vitrimer can be pulverized and hot pressed for example at 150° C., 0.5 MPa for 5 minutes.

The vitrimer of this disclosure can also be easily converted under mild conditions in the presence of ring closing metathesis catalyst back to monomers with high yield and high selectivity.

### Process for Preparing Vitrimer

A further aspect of this disclosure is directed to a process for preparing the vitrimers of this disclosure, which comprises polymerizing cyclopentene, compound (1) of this disclosure and optional comonomer via ring-opening metathesis polymerization to form the vitrimer in one step. Compound (1) is as defined above.

In this disclosure, the ring-opening metathesis polymerization is carried out in the presence of a catalyst.

The polymerization temperature of the present invention may be in the range from −30° C. to 50° C. (for example −25° C., −20° C., −15° C., −10° C., −5° C., 0° C., 5° C., 10° C., 15° C., 20° C., 25° C., 30° C., 35° C., 40° C., 45° C., or 50° C.), or from −30° C. to 40° C., or from −30° C. to 30° C. In an embodiment, the catalyst is added at a lower temperature, for example from −30° C. to −20° C., after the addition of the catalyst, the temperature can be increased, for example to from 15° C. to 50° C., or from 20° C. to 40° C., or from 20° C. to 30° C.

The polymerization time is usually in the range from 1 hour to 10 hours (for example 1.5, 2, 3, 4, 5, 6, 8 or 10 hours), or from 1.5 hours to 8 hours, or from 1.5 hours to 5 hours.

The catalyst for ring-opening metathesis polymerization of the present invention is a compound that catalyzes the ring-opening metathesis polymerization.

The catalyst for ROMP may include a metal, for example, tungsten (W), molybdenum (Mo), rhenium (Re), ruthenium (Ru), titanium (Ti), and/or osmium (Os).

In some embodiments of the invention, the ring-opening metathesis polymerization catalyst is represented by the formula:

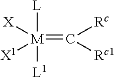

wherein:
   M is a Group 8 metal, preferably Ru or Os, more preferably Ru;
   X and X¹ are, independently, any anionic ligand, preferably a halogen (preferably chlorine), an alkoxide or a triflate, or X and X¹ may be joined to form a dianionic group and may form a single ring of up to 30 non-hydrogen atoms or a multinuclear ring system of up to 30 non-hydrogen atoms;
L and L¹ are, independently, a neutral two electron donor, preferably a phosphine or a N-heterocyclic carbene, L and L¹ may be joined to form a single ring of up to 30 non-hydrogen atoms or a multinuclear ring system of up to 30 non-hydrogen atoms;
L and X may be joined to form a multidentate monoanionic group and may form a single ring of up to 30 non-hydrogen atoms or a multinuclear ring system of up to 30 non-hydrogen atoms;
L¹ and X¹ may be joined to form a multidentate monoanionic group and may form a single ring of up to 30 non-hydrogen atoms or a multinuclear ring system of up to 30 non-hydrogen atoms;
R^{c} and R^{c1} are, independently, hydrogen, halogen, or C₁ to C₂₀ substituted or unsubstituted hydrocarbyl (preferably C₁ to C₂₀ substituted or unsubstituted alkyl or a substituted or unsubstituted C₆ to C₂₀ aryl) which may contain at least one atom selected from halogen, oxygen, nitrogen, sulfur, phosphorus and silicon atoms;
R^{c1} and L¹ or X¹ may be joined to form a single ring of up to 30 non-hydrogen atoms or a multinuclear ring system of up to 30 non-hydrogen atoms; and
R^{c} and L or X may be joined to form a single ring of up to 30 non-hydrogen atoms or a multinuclear ring system of up to 30 non-hydrogen atoms.

Preferred alkoxides include those wherein the alkyl group is C₁ to C₁₀ hydrocarbyl, preferably C₁ to C₁₀ alkyl group, preferably methyl, ethyl, propyl, butyl, or phenyl, or include those derived from a phenol, substituted phenol (where the phenol may be substituted with up to 1, 2, 3, 4, or 5 C₁ to C₁₂ hydrocarbyl groups).

Preferred phosphines are represented by the formula: PR³′ R⁴′ R⁵′, where R³′ is a secondary alkyl or cycloalkyl (preferably a C₃ to C₁₂ secondary alkyl or cycloalkyl), and R⁴′ and R⁵′ are aryl, C₁ to C₁₀ primary alkyl, secondary alkyl, or cycloalkyl. R⁴′ and R⁵′ may be the same or different. Preferred phosphines include P(cyclohexyl)₃, P(cyclopentyl)₃, and/or P(isopropyl)₃.

Preferred triflates are represented by the formula:

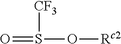

wherein R^{c2} is hydrogen or C₁ to C₃₀ hydrocarbyl group, preferably C₁ to C₁₂ alkyl group, preferably methyl, ethyl, propyl, butyl, or phenyl.

Preferred N-heterocyclic carbenes are represented by the formulae of:

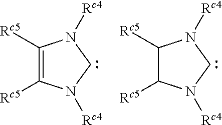

wherein:
   each R^{c4} is independently a hydrocarbyl group or substituted hydrocarbyl group having 1 to 40 carbon atoms, preferably methyl, ethyl, propyl, butyl (including isobutyl and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, tolulyl, chlorophenyl, phenol, or substituted phenol; and
   each R^{c5} is hydrogen, a halogen, or C₁ to C₁₂ hydrocarbyl group, preferably hydrogen, bromine, chlorine, methyl, ethyl, propyl, butyl, or phenyl. In other useful embodiments, one of the N groups bound to the carbene in these formulae may be replaced with an S, O, or P atom, preferably an S atom.

Other useful N-heterocyclic carbenes include the compounds described in Hermann, W. A. (1996) Chem. Eur. J., v.2, pp. 772 and 1627; Enders, D. et al. (1995) Angew. Chem. Int. Ed., v.34, pg. 1021; Alder R. W. (1996) Angew. Chem. Int. Ed., v.35, pg. 1121; and Bertrand, G. et al. (2000) Chem. Rev., v.100, pg. 39.

In an embodiment, the ring-opening metathesis polymerization catalyst is one or more of tricyclohexylphosphine[1,3-bis(2,4,6-trimethylphenyl)imidazol-2-ylidene][3-phenyl-1H-inden-1-ylidene]ruthenium(II)dichloride,tricyclohexylphosphine[3-phenyl-1H-inden-1-ylidene][1,3-bis(2,4,6-trimethylphenyl)-4,5-dihydro-imidazol-2-ylidene]ruthenium(II) dichloride, tricyclohexylphosphine[1,3-bis(2,4,6-trimethylphenyl)-4,5-dihydroimidazol-2-ylidene][(phenylthio)methylene]ruthenium(II) dichloride, bis(tricyclohexylphosphine)-3-phenyl-1H-inden-1-ylidene ruthenium (II) dichloride, 1,3-Bis(2,4,6-trimethylphenyl)-4,5-dihydroimidazol-2-ylidene[2-(i-propoxy)-5-(N,N-dimethylaminosulfonyl)phenyl]methylene ruthenium(II) dichloride, and [1,3-Bis(2,4,6-trimethylphenyl)-2-imidazolidinylidene]-[2-[[(4-methylphenyl)imino]methyl]-4-nitrophenolyl]-[3-phenyl-1H-inden-1-ylidene]ruthenium(II) chloride, dichloro[1,3-bis(2,6-isopropylphenyl)-2-imidazolidinylidene](benzylidene)(tricyclohexylphosphine)ruthenium (II) (M206). In some embodiments, the ring-opening metathesis polymerization catalyst is 1,3-Bis(2,4,6-trimethylphenyl)-4,5-dihydroimidazol-2-ylidene[2-(i-propoxy)-5-(N,N-dimethylaminosulfonyl)phenyl]methylene ruthenium(II) dichloride, Tricyclohexylphosphine[3-phenyl-1H-inden-1-ylidene][1,3-bis(2,4,6-trimethylphenyl)-4,5-dihydroimidazol-2-ylidene]ruthenium(II) dichloride, and/or dichloro[1,3-bis(2,6-isopropylphenyl)-2-imidazolidinylidene](benzylidene)(tricyclohexylphosphine)ruthenium(II) (M206).

The amount of the ring-opening metathesis polymerization catalyst that is employed in the process of this disclosure is any amount that provides an operable ring-opening metathesis polymerization. Preferably, the molar ratio of the monomer added to the catalyst is typically not less than 1,000:1; not less than 5,000:1; not less than 10,000:1; not less than 25,000:1; not less than 50,000:1; not less than 75,000:1; or not less than 100,000:1. In an embodiment, the molar ratio of the monomer added to the catalyst is typically in the range from 1,000:1 to 2,000,000:1 (for example 2,000:1, 5,000:1, 8,000:1, 10,000:1, 20,000:1, 50,000:1, 80,000:1, 100,000:1, 200,000:1, 500,000:1, 800,000:1, 1,000,000:1, or 1,500,000:1), or from 5000:1 to 1,000,000:1, or from 8,000:1 to 500,000:1, or from 10,000:1 to 250,000:1, or from 50,000:1 to 200,000:1.

The polymerization of the process of this disclosure can be carried out in inert solvent. The term “inert solvent” means that the solvent does not react with the catalyst and may be capable of dissolving the obtained polymer. Examples of the solvent for polymerization of the process of the present invention include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof such as commercial product (Isopar™); aromatic compounds such as benzene, toluene, mesitylene, ethyl benzene, and xylene; halohydrocarbons such as dichloromethane, dichloroethane, tetrachloroethane, chlorobenzene and trichlorobenzene; ethers such as tetrahydrofuran; amides such as dimethylformamide; sulfoxides such as dimethyl sulfoxide.

In some embodiments of this disclosure, the solvent for polymerization of the process may be selected from dichloromethane, tetrahydrofuran, dimethylformamide, toluene, or xylene.

In an embodiment, the polymerization of the process of this disclosure can be carried out in the presence of substantially no inert solvent. As used herein, “substantially no inert solvent” means the amount of inert solvent is no more than 5 wt %, or no more than 4 wt %, or no more than 3 wt %, or no more than 2 wt %, based on the weight of the monomers.

At the termination of ring-opening metathesis polymerization, vinyl compounds such as 1-butene, 1-pentene, 1-hexene, 1-octene, alkyl vinyl ethers such as ethyl vinyl ether can be added to terminate the polymerization.

In an embodiment, the vitrimer can undergo separation.

For separating the vitrimer obtained from the polymerization, the vitrimer may be diluted, precipitated, and washed, and dried. Usually, the temperature for drying is no more than 85° C., or no more than 75° C., or no more than 65° C., for example from 40° C. to 85° C., from 45° C. to 75° C., or from 50° C. to 65° C.

### Process for Preparing Compound (1)

A further aspect of this disclosure is directed to a process of preparing compound (1) of this disclosure comprising:
(i) reacting a B-containing compound with a polyol-type compound to form a compound containing at least one reversible borate moiety or derivative thereof and one hydroxyl;
(ii) reacting the compound containing at least one reversible borate moiety or derivative thereof and one hydroxyl obtained in step (i) with a compound containing a carboxyl and a cyclic olefin group to form compound (1),
wherein the B-containing compound is selected from a compound having a structure of B(QR)₃ and a compound having at least two B(QR)₂ groups, wherein R is selected from H or C₁-C₆-alkyl and each Q is independently an element of the sixth main group, or oxygen or sulfur; and
wherein the polyol-type compound has three hydroxyls and two of them are capable of forming the reversible borate moiety or derivative thereof with the B-containing compound, or the polyol-type compound has one hydroxyl and one ethylene oxide ring or oxetane ring.

In this disclosure, the B-containing compound can be selected from a compound having a structure of B(QR)₃ and a compound having at least two (for example 2, 3 or 4) B(QR)₂ groups, wherein R is selected from H or C₁-C₆-alkyl, for example methyl, ethyl, propyl or butyl and each Q is independently an element of the sixth main group, or oxygen or sulfur. In an embodiment, R is H. In an embodiment, R is C₁-C₆-alkyl, for example methyl, ethyl, propyl or butyl.

In an embodiment, R can be C₁-C₆-alkyl, for example methyl, ethyl or propyl, preferably methyl or ethyl in the structure of B(QR)₃. In an embodiment, R can be H in the structure of B(QR)₂.

The B-containing compound can be selected from trimethyl borate, triethyl borate, tri-n-propyl borate, tri-isopropyl borate, tri-butyl borate, tri-tert-butyl borate, benzen-1,4-diboronic acid, 2,5-thiophenediboranic acid, 4,4-biphenyldiboronic acid, polyboric acid and tetrahydroxydiboron and ((((oxybis(ethane-2,1-diyl))bis(oxy))bis(methylene))bis(4,1-phenylene))diboronic acid.

In this disclosure, the polyol-type compound has three hydroxyls and two of them are capable of forming the reversible borate moiety or derivative thereof with the B-containing compound, or the polyol-type compound has one hydroxyl and one ethylene oxide ring or oxetane ring. Said two hydroxyls capable of forming the reversible borate moiety or derivative thereof with the B-containing compound have the following structure: two carbon atoms carrying said two hydroxyls are in ortho position (for example 1,2-diol structure) or is interrupted by one carbon atom (for example 1,3-diol structure).

In an embodiment, the polyol-type compound is selected from the compound of following formulae:

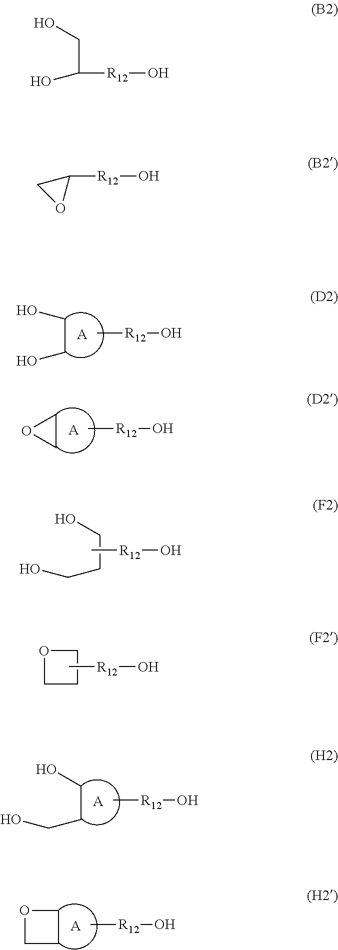

wherein ring A and R₁₂ are as defined above.

For example, R₁₂ is a divalent hydrocarbyl (for example alkylene) having 1 to 12, or 1 to 6, or 1 to 4, or 2 to 12, or 2 to 6, or 3 to 12, or 3 to 6 carbon atoms, which can optionally be interrupted by one or more nonadjacent oxygen atoms, and/or one or more nonadjacent carbon atoms in the divalent hydrocarbyl (for example alkylene) can optionally be replaced with —(CO)—O— and/or CO.

The compound containing a carboxyl and a cyclic olefin group may be a compound of the following formula

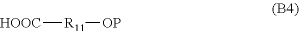

wherein OP is a cyclic olefin group, and R₁₁ are as defined above.

For example, R₁₁ is a direct bond or divalent hydrocarbyl (for example alkylene) having 1 to 12 or 1 to 6 or 1 to 4 carbon atoms, which can optionally be interrupted by one or more nonadjacent oxygen atoms, and/or one or more nonadjacent carbon atoms in the divalent hydrocarbyl (for example alkylene) can optionally be replaced with —(CO)—O— and/or CO.

OP is a cyclic olefin group. The specific definition of OP is as mentioned above.

The reaction in step (i) can be carried out in the presence of water trapping agent, such as magnesium sulphate or molecular sieve for example, or by using a Dean-Stark apparatus which allows water formed during condensation to be removed by distillation. Preferably, the reaction in step (i) is carried out at an elevated temperature, for example at from 105° C. to 160° C., or at from 110° C. to 150° C. The reaction in step (i) is preferably carried out at inert atmosphere, for example at nitrogen atmosphere. The reaction time in step (i) can be in the range from 3 hours to 30 hours, or 5 hours to 25 hours. The reaction in step (i) can be carried out in the presence of sulfonic acid, for example toluenesulfonic acid. The reaction in step (i) can be carried out in the presence of a solvent, for example an aromatic hydrocarbon, such as toluene.

The reaction in step (ii) is carried out at an elevated temperature, for example at from 105° C. to 160° C., or at from 110° C. to 150° C. The reaction in step (ii) is preferably carried out at inert atmosphere, for example at nitrogen atmosphere. The reaction time in step (ii) can be in the range from 3 hours to 30 hours, or 5 hours to 25 hours. The reaction in step (ii) can be carried out in the presence of sulfonic acid, for example toluenesulfonic acid. The reaction in step (ii) can be carried out in the presence of a solvent, for example an aromatic hydrocarbon, such as toluene.

In an embodiment, compound (1) comprises at least two (for example 2 or 3) reversible borate moieties or derivative thereof.

In an embodiment, this disclosure provides a process of preparing compound of Formula (B)

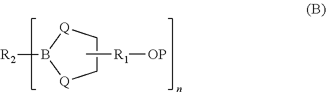

wherein R₂, Q, OP and n are as defined above, or two -Q-B-Q- moieties share one B atom and form a spiro ring;
   each R₁ is independently R₁₁—(CO)—O—R₁₂, wherein R₁₁ and R₁₂ are as defined above, wherein the process comprises
   (i) reacting a compound of Formula (B1)

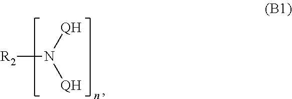

wherein R₂, Q and n are as defined above,
   with a compound of Formula (B2) or a compound of Formula (B2′)

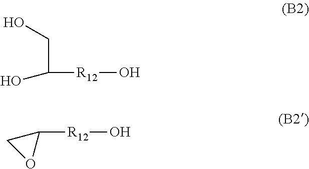

wherein R₁₂ is as defined above,
   to obtain a compound of Formula (B3)

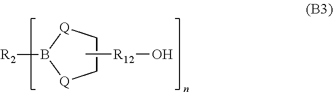

wherein R₂, R₁₂, Q and n are as defined above, and
   (ii) reacting the compound of Formula (B3) with a compound of Formula (B4)

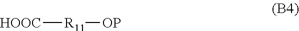

wherein R₁₁ and OP are as defined above;
   to obtain the compound of Formula (B).

In an embodiment, this disclosure provides a process of preparing compound of Formula (D)

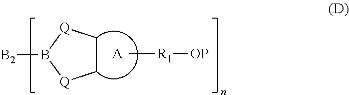

wherein ring A, R₂, Q, OP and n are as defined above; or two -Q-B-Q- moieties share one B atom and form a spiro ring,
   each R₁ is independently R₁₁—(CO)—O—R₁₂, wherein R₁₁ and R₁₂ are as defined above,
   wherein the process comprises
   (i) reacting a compound of Formula (B1)

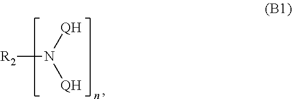

wherein R₂, Q and n are as defined above,
   with a compound of Formula (D2) or a compound of Formula (D2′)

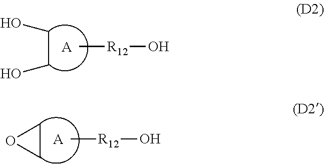

wherein A and R₁₂ are as defined above,
   to obtain a compound of Formula (D3)

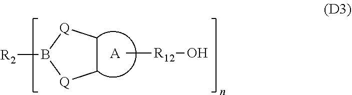

wherein R₂, R₁₂, A, Q and n are as defined above, and
   (ii) reacting the compound of Formula (D3) with a compound of Formula (B4)

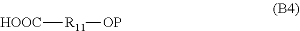

wherein R₁₁ and OP are as defined above;
   to obtain the compound of Formula (D).

In an embodiment, this disclosure provides a process of preparing compound of Formula (F)

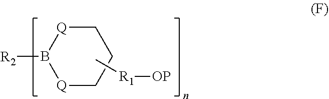

wherein R₂, Q, OP and n are as defined above; or two -Q-B-Q- moieties share one B atom and form a spiro ring,
   each R₁ is independently R₁₁—(CO)—O—R₁₂, wherein R₁₁ and R₁₂ are as defined above, wherein the process comprises
   (i) reacting a compound of Formula (B1)

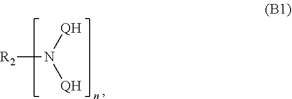

wherein R₂, Q and n are as defined above,
   with a compound of Formula (F2) or a compound of Formula (F2′)

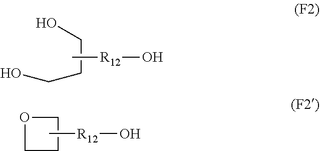

wherein R₁₂ is as defined above,
   to obtain a compound of Formula (F3)

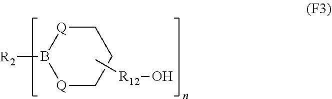

wherein R₂, R₁₂, Q and n are as defined above, and
   (ii) reacting the compound of Formula (F3) with a compound of Formula (B4)

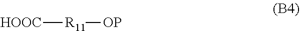

wherein R₁₁ and OP are as defined above; to obtain the compound of Formula (F).

In an embodiment, this disclosure provides a process of preparing compound of Formula (H)

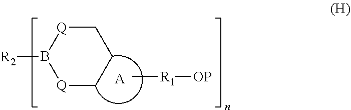

wherein ring A, R₂, Q, OP and n are as defined above; or two -Q-B-Q- moieties share one B atom and form a spiro ring, each R₁ is independently R₁₁—(CO)—O—R₁₂, wherein R₁₁ and R₁₂ are as defined above,
wherein the process comprises
   (i) reacting a compound of Formula (B1)

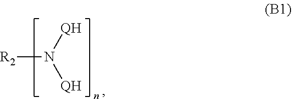

wherein R₂, Q and n are as defined above, with a compound of Formula (H2) or a compound of Formula (H2′)

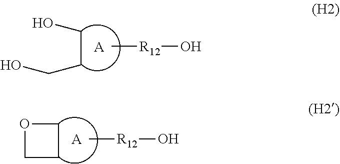

wherein ring A and R₁₂ are as defined above, to obtain a compound of Formula (H3)

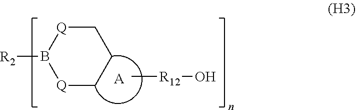

wherein R₂, R₁₂, Q, ring A and n are as defined above, and
   (ii) reacting the compound of Formula (H3) with a compound of Formula (B4)

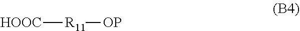

wherein R₁₁ and OP are as defined above; and to obtain the compound of Formula (H). Preferably, Q is oxygen in Formulae (B), (D), (F) and (H).

### Vulcanized Vitrimer

A further aspect of this disclosure is directed to a vulcanized vitrimer, which is formed by vulcanizing the vitrimer of this disclosure.

The vitrimer of the present disclosure may be vulcanized by adding curative agents (for example, sulfur), metal fatty acids, accelerators and activators, and if necessary other agents common in the art.

The vitrimer may be vulcanized (cured) by any suitable means, such as subjecting them to heat or radiation according to any conventional vulcanization process. The amount of heat or radiation needed is that which is required to affect a cure in the disclosure, and the disclosure is not herein limited by the method and amount of heat required to cure the composition. Typically, the vulcanization is conducted at a temperature ranging from 100° C. to about 250° C., or ranging from 120° C. to 200° C., or ranging from 130° C. to 180° C., for 50 minutes to 200 minutes or for 90 minutes to 160 minutes.

The metal fatty acid can be for example zinc stearate or calcium stearate, etc. The metal fatty acid can be used alone or in conjunction with its corresponding metal oxides, for example ZnO and CaO. The amount of the metal fatty acid can be in the range from 0.1 phr to 5 phr, such as from 0.2 phr to 2 phr.

Sulfur is the most common chemical vulcanizing agent. The sulfur vulcanization system may comprise an activator to activate the sulfur, an accelerator, and a retarder to help control the rate of vulcanization.

General classes of accelerators include amines, diamines, guanidines, thioureas, thiazoles, thiurams, sulfenamides, sulfenimides, thiocarbamates, xanthates, and the combination thereof. The amounts of accelerators can be in the range from 0.1 phr to 10 phr, or 0.2 phr to 5 phr, or 0.3 phr to 4 phr.

Accelerators help control the onset and rate of vulcanization, and the number and type of crosslinks that are formed. Retarders may be used to delay the initial onset of cure in order to allow sufficient time to process the unvulcanized rubber.

Numerous accelerators are known in the art and include, but are not limited to, the following: stearic acid, diphenyl guanidine (DPG), tetramethylthiuram disulfide (TMTD), benzothiazyl disulfide (MBTS), N-t-butyl-2-benzothiazole sulfenamide (TBBS), N-cyclohexyl-2-benzothiazole-sulfenamide (CBS), and thioureas.

The amount of curing agent (for example sulfur) can be in the range from 0.2 phr to 8 phr (for example 0.3, 0.4, 0.5, 0.6, 0.7, 0.8, 0.9, 1, 1.2, 1.5, 2, 3, 4, 5, 6, 7 or 8 phr), or from 0.3 phr to 5 phr, or from 0.4 phr to 2 phr, based on 100 phr vitrimer.

In an embodiment, the tensile stress at 1000% strain of the vulcanized vitrimer is at least about 110% (for example 115%, 120%, 125%, 130%, 135%, 140%, 150%, or 160%) or at least about 115% or at least about 120% or at least about 125% of the tensile stress at 1000% strain of the vulcanized neat cyclopentene-based ring-opening polyolefin. In an embodiment, the tensile stress at 1000% strain of the vulcanized vitrimer is from about 110% to 160%, or from about 115% to 150%, or from about 120% to 140% of the tensile stress at 1000% strain of the vulcanized neat cyclopentene-based ring-opening polyolefin.

### Composition

A further aspect of this disclosure is directed to a composition comprising the vitrimer of this disclosure or the vulcanized vitrimer and at least one additive. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates and hydrogenated rosins; UV stabilizers; heat stabilizers; antiblocking agents; release agents; anti-static agents; pigments; colorants; dyes; waxes; silica; fillers; talc; modifier; and the like.

### Blending and Processing of Vitrimer, Vulcanized Vitrimer and Composition

The vitrimer and composition described herein may be processed or formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twinscrew extruder, which may include a compounding extruder and a side-arm extruder used directly downstream of a polymerization process. Additionally, additives may be included in the vitrimer, blend, in one or more components of the blend, and/or in a product formed from the blend, such as a film, as desired. Examples of additives are as described above.

The vitrimer can be in any physical form. In an embodiment, reactor granules, defined as the granules of vitrimer that are isolated from the polymerization reactor prior to any processing procedures, are used. In another embodiment, the vitrimer is in the form of pellets that are formed from melt extrusion. The vitrimers can be in above mentioned physical form when used to blend with the additive.

The components can be blended by any suitable means, and are typically blended to yield an intimately mixed composition. For example, they may be blended in a static mixer, batch mixer, extruder, or a combination thereof, that is sufficient to achieve an adequate dispersion of additive in the vitrimer.

The mixing step may involve first dry blending using, for example, a tumble blender, where the vitrimer and additive are brought into contact first, without intimate mixing, which may then be followed by melt blending in an extruder. Another method of blending the components is to melt blend the vitrimer pellets with the additive directly in an extruder or batch mixer. It may also involve a “master batch” approach, where the final additive concentration is achieved by combining vitrimer with an appropriate amount of additive that had been previously prepared at a higher additive concentration. The mixing step may take place as part of a processing method used to fabricate articles, such as in the extruder on an injection molding machine or blown-film line or fiber line.

In a preferred aspect of this disclosure, the vitrimer and additive are “melt blended” in an apparatus such as an extruder (single or twin screw) or batch mixer. The vitrimer may also be “dry blended” with the additive using a tumbler, double-cone blender, ribbon blender, or other suitable blender. In yet another embodiment, the vitrimer and additive are blended by a combination of approaches, for example a tumbler followed by an extruder. A preferred method of blending is to include the final stage of blending as part of an article fabrication step, such as in the extruder used to melt and convey the composition for a molding step like injection molding or blow molding. This could include direct injection of the additive into the extruder, either before or after the vitrimer is fully melted. Extrusion technology for polymer can reference, for example, PLASTICS EXTRUSION TECHNOLOGY 26-37 (Friedhelm Hensen, ed. Hanser Publishers 1988).

In another aspect of this disclosure, the composition may be blended in solution by any suitable means, by using a solvent that dissolves components to a significant extent. The blending may occur at any temperature or pressure where the additive and the vitrimer remain in solution. As with the solution process the additive is added directly to the finishing train, rather than added to the dry vitrimer in another blending step altogether.

Thus, in the cases of fabrication of articles using methods that involve an extruder, such as injection molding or blow molding, any means of combining the vitrimer and additive to achieve the desired composition serve equally well as fully formulated pre-blended pellets, since the forming process includes a re-melting and mixing of the raw material; example combinations include simple blends of vitrimer pellets and additive, of vitrimer granules and additive, of vitrimer pellets and pre-blended pellets, and vitrimer granules and pre-blended pellets. Here, “pre-blended pellets” means pellets of a composition comprising vitrimer and additive at some concentration. In the process of compression molding, however, little mixing of the melt components occurs, and pre-blended pellets would be preferred over simple blends of the constituent pellets (or granules) and additive. Those skilled in the art will be able to determine the appropriate procedure for blending of the vitrimers to balance the need for intimate mixing of the component ingredients with the desire for process economy.

### Article

A further aspect of the present invention is directed to an article comprising the vitrimer, the vulcanized vitrimer or the composition of this disclosure.

The article can be an extruded article, molded article, hose, sheet, film, jacket or foam. For example, the article includes, but are not limited to, an extruded article, such as an auto weather-seal, a non-auto weather-seal, a building profile, etc.; a molded article, such as a seal, a gasket, etc.; a hose, such as air hose, heat hose, garden hose, industry hose, etc.; a sheet, such as a roof sheet; a film; a jacket, such as a cable jacket, or a foam.

### EXAMPLES

### Example 1—Synthesis of Diboronic Ester Dicyclopentene (DBDCP) Crosslinker

The diboronic ester dicyclopentene (DBDCP, B-containing monomer, compound 1) crosslinker was synthesized according to scheme 1:

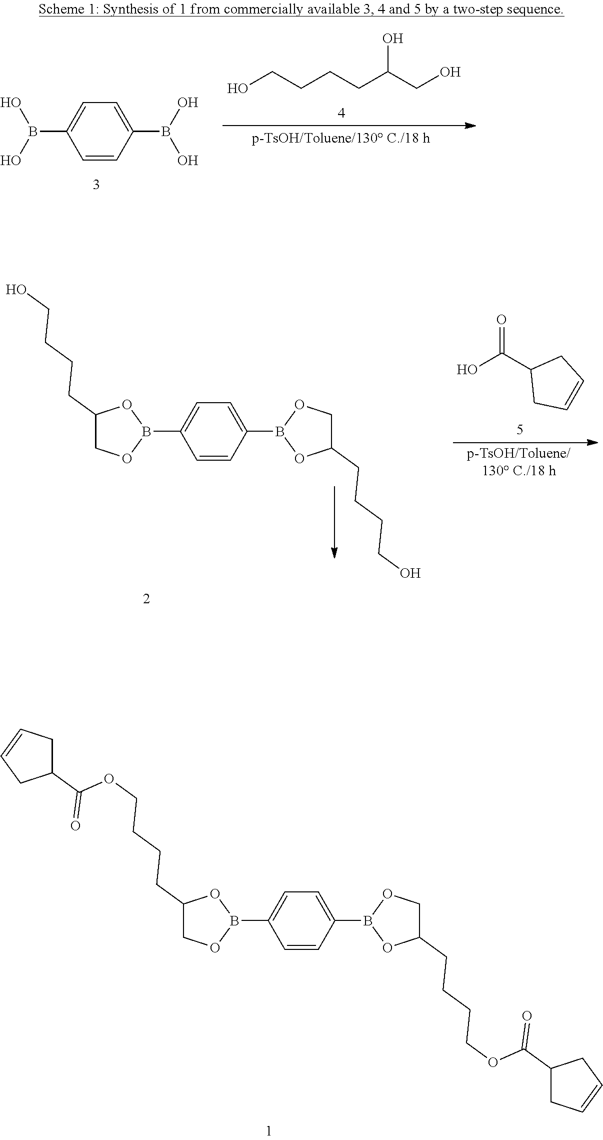 [SMILES: OCCCCC(O)CO ; OB(O)c1ccc(B(O)O)cc1 ; OCCCCC1COB(c2ccc(B3OCC(CCCCO)O3)cc2)O1 ; O=C(O)C1CC=CC1 ; O=C(OCCCCC1COB(c2ccc(B3OCC(CCCCOC(=O)C4CC=CC4)O3)cc2)O1)C1CC=CC1]

Synthesis of 4,4′-(1,4-phenylenebis(1,3,2-dioxaborolane-2,4-diyl))bis(butan-1-ol) (2)-Under nitrogen atmosphere, to a 1 L single-neck round bottom flask equipped with a magnetic stir bar was added benzene-1,4-diboronic acid 3 (50.0 g, 301.6 mmol), 1,2,6-hexanetriol 4 (85.0 g, 633.5 mmol), anhydrous toluene (500 mL) and p-toluenesulfonic acid (20 mg). The reaction mixture was refluxed at 130° C. with a Dean-Stark trap for 18 hours. The solvent was removed by rotary evaporation. To the same flask was added cold toluene (500 mL) and the mixture was stirred at room temperature for 30 minutes before it was filtered to remove any solids and condensed brown oil. The solvent in the filtrate was removed by rotary evaporation and dried under 60° C. vacuum for 18 hours to afford 2 as a dark yellow oil (86.6 g, 239.2 mmol, 79.3% yield). 1H NMR (500 MHz, CDCl₃) δ 7.82 (s, 4H), 4.59 (t, 2H), 4.44 (t, 2H), 3.96 (t, 2H), 3.68 (t, 4H), 1.80-1.40 (m, 12H). These ¹H NMR data excluded the ones in —OH groups, which were labile.

Synthesis of (1,4-phenylenebis(1,3,2-dioxaborolane-2,4-diyl))bis(butane-4,1-diyl)bis(cyclopent-3-ene-1-carboxylate) (1)—Under nitrogen atmosphere, to a 250 mL single-neck round bottom flask equipped with a magnetic stir bar was added 4,4′-(1,4-phenylenebis(1,3,2-dioxaborolane-2,4-diyl))bis(butan-1-ol) 2 (16.0 g, 46.4 mmol), 3-cyclopentene-1-carboxylic acid 5 (10.9 g, 97.4 mmol), anhydrous toluene (150 mL), and p-toluenesulfonic acid (20 mg). The reaction mixture was refluxed at 130° C. with a Dean-Stark trap for 18 hours. After cooled down to room temperature, the reaction mixture was filtered to remove the solids floating in the solution. The solvent in the collected filtrate was removed by rotary evaporation to afford 1 as a dark yellow oil (25.0 g, 45.4 mmol, 97.9% yield). ¹H NMR (500 MHz, CDCl₃) δ 7.84 (s, 4H), 5.68 (m, 4H), 4.59 (m, 2H), 4.45 (m, 2H), 4.15 (t, 2H), 3.96 (t, 2H), 3.69 (m, 2H), 3.14 (m, 2H), 2.67 (m, 8H), 1.64 (m, 12H).

### Example 2—Vitrimers (CPR-V1)

The Ru catalyst (dichloro[1,3-bis(2,6-isopropylphenyl)-2-imidazolidinylidene](benzylidene) (tricyclohexylphosphine) ruthenium (II) (M206), 20 mg, 0.0214 mmol) was dissolved in 2 mL of DCM. The resulting solution (274 microL, 0.00293 mmol of the catalyst) was used for the addition into the reaction mixture consisting of the B-containing monomer (4.04 g, 58.7 mmol) and cyclopentene (20 g, 294 mmol) cooled to −35° C. Cyclopentene was homemade and obtained from depolymerization (see WO2021/242636) of polypentenamers [>99.9% purity]. The mixture was stirred for 2 hours while slowly warming to 25° C. Then, a few drops of ethyl vinyl ether were added and the mixture was diluted with dichloromethane (100 mL). The product was precipitated by adding iso-propanol (300 mL) containing BHT (1 g) and washed with iso-propanol 2 times (50 mL each) before drying in the oven for 3 hours at 55° C. The product was isolated as a solid material (12.73 g, 53% yield). The cyclopentene: B-containing monomer incorporation was estimated based on 1H NMR (145:1). Cis/trans 20/80. GPC-ID: Mw 345 kDa, PDI 2.30.

The product (CPR-V1) was easily converted back to monomers with high yield and high selectivity. The process for depolymerizing the vitrimer was the same as the process used to depolymerize polypentenamer.

### Example 3—Vitrimers (CPR-V2)

The Ru catalyst (dichloro[1,3-bis(2,6-isopropylphenyl)-2-imidazolidinylidene](benzylidene)(tricyclohexylphosphine)ruthenium(II) (M206), 25 mg, 0.0268 mmol) was dissolved in 2 mL of DCM. The resulting solution (274 microL, 0.0037 mmol of the catalyst) was used for the addition into the reaction mixture consisting of the B-containing monomer (20 g, 291 mmol) and cyclopentene (20 g, 294 mmol) cooled to −35° C. Cyclopentene was homemade and obtained from depolymerization of polypentenamers [>99.9% purity]. The mixture was stirred for 2 hours while slowly warming to 25° C. Then, a few drops of ethyl vinyl ether were added, and the mixture was diluted with dichloromethane (100 mL). The product was precipitated by adding iso-propanol (300 mL) containing BHT (1 g) and washed with iso-propanol 2 times (50 mL each) before drying in the oven for 3 hours at 55° C. The product was isolated as a solid material (13.0 g, 33% yield). The cyclopentene: B-containing monomer incorporation was estimated based on ¹H NMR (29:1). Cis/trans 20/80. GPC-1D: Mw 407 kDa, PDI 1.89.

The product (CPR-V2) was easily converted back to monomers with high yield and high selectivity. The process for depolymerizing the vitrimer was the same as the process used to depolymerize polypentenamer.

### Thermal Behavior

DSC was used to measure Tg (glass transition temperature), Tm (melting point) and heat of melting (ΔHm) for the polypentenamer homopolymer (CPR) and the two vitrimers (CPR-V1, and CPR-V2) at a heating rate of 10° C./min, the results were shown in table 1.

TABLE 1
Thermal properties of CPR and vitrimers (CPR-V1 and CPR-V2)

| | | DBDCP | Mw, | | Tg, | Tm, | ΔHm, |
|---|---|---|---|---|---|---|---|
| Example | Name | mole % | kg/mol | Mw/Mn | ° C. | ° C. | J/g |
| | CPR* | 0 | 227 | 2.06 | −97.1 | 12.0 | 44.4 |
| 2 | CPR-V1 | 0.7 | 345 | 2.30 | −93.4 | 6.53 | 38.7 |
| 3 | CPR-V2 | 3.33 | 407 | 1.90 | −88.6 | −7.75 | 28.8 |

*The molar ratio of cis/trans was 20/80 in CPR.

### Rheological Response

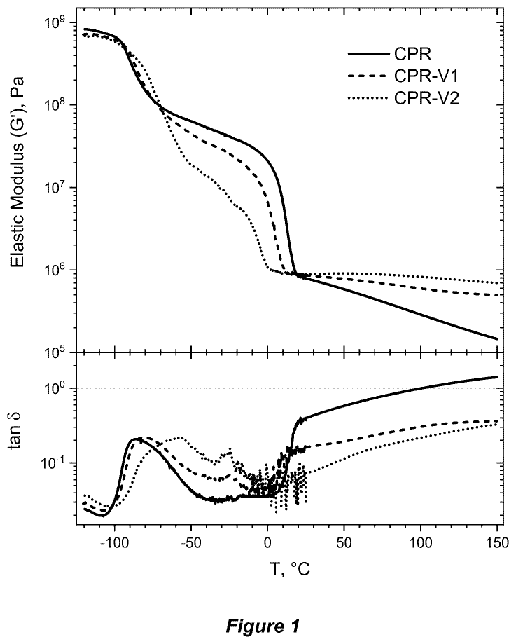

Dynamic thermal-mechanical analysis (DMTA) data of the CPR homopolymer and the vitrimers were shown in FIG. 1, the temperature ramps were performed at a heating rate of 2° C./min. Above the melting temperature (marked by the sharp drop in moduli), the CPR homopolymer showed the typical steady decrease in moduli and the crossover temperature above which G′ became less than G″ (and tan δ>1), which indicated that the polymer loses elasticity and became more “liquid-like”. This crossover was not observed in the vitrimer samples, which indicated that the sample remained highly elastic at temperature up to 150° C. The results of G′ and tan δ at 150° C. were also shown in table 2.

TABLE 2

| Example | Name | G′(kPa) | Tan δ |
|---|---|---|---|
| | CPR | 147 | 1.4 |
| 2 | CPR-V1 | 495 | 0.36 |
| 3 | CPR-V2 | 693 | 0.33 |

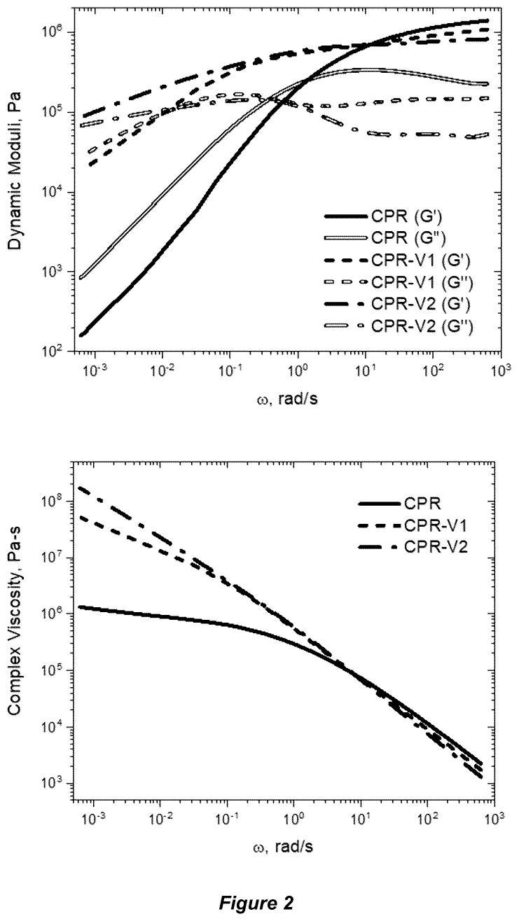

Additional evidence of network formation was provided in FIG. 2, which showed the dynamic frequency sweeps (DFS), measured at 50° C., of the CPR homopolymer and the vitrimers CPR-V1 and CPR-V2. The homopolymer showed the typical G′ and G″ crossover, the G′<G″ relationship and the viscosity plateau at low frequencies, corresponding to the zero-shear viscosity, which corresponds to the relaxation process of an entangled polymer melt. The low-frequency elastic modulus in the vitrimer samples was one to two orders of magnitude larger than that in the homopolymer. This indicated solid-like behavior in the vitrimers. However, the vitrimer samples could be reprocessed at temperatures above the melting temperature. As shown in FIG. 2, the complex viscosities of CRP, CPR-V1 and CPR-V2 were 1.31 MPa·s, 50.2 MPa·s, and 172 MPa·s, respectively, at a frequency of 10⁻³ rad/s.

### Tensile Properties

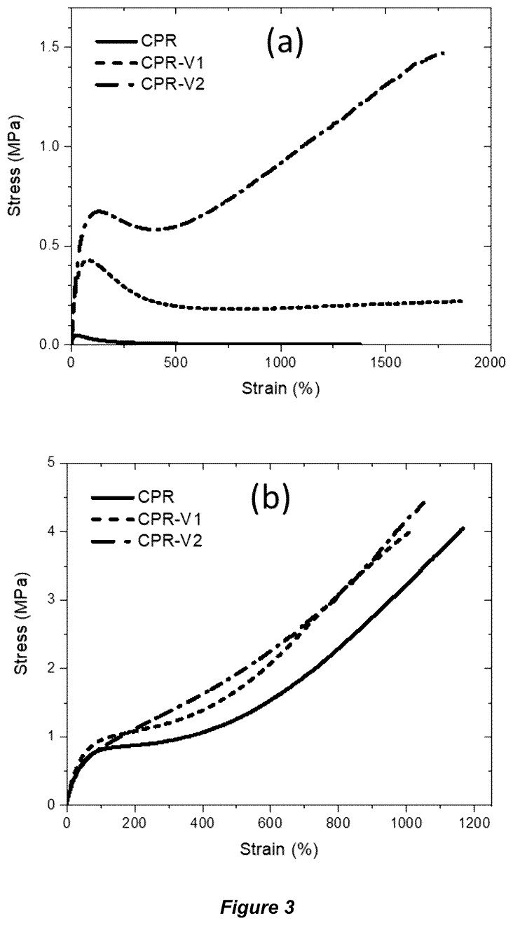

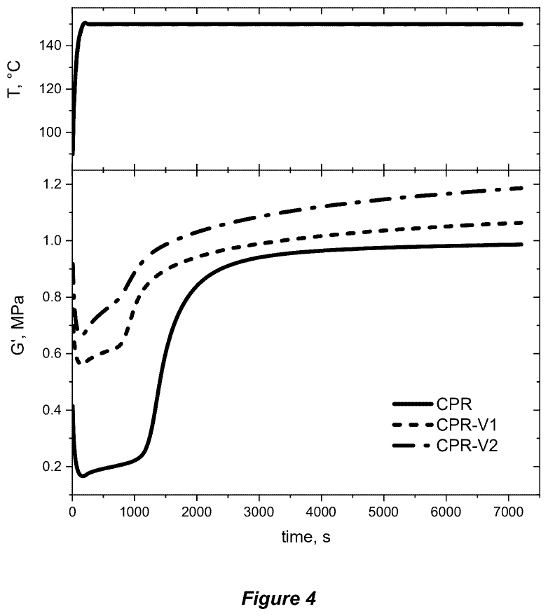

CPR homopolymer and vitrimer samples were compression molded into dog bone-shaped specimens (0.3 mm×2 mm×7 mm) in a hot press preheated at 80° C. Tensile and hysteresis tests were performed by uniaxially stretching in a solid analyzed instrument (RSA-G2, TA Instruments) at 25° C. and with a linear deformation rate of 100 microns/s. Two sets of samples were analyzed. The first one was uncured samples. In the second set, 100 phr CPR or vitrimer were mixed with sulfur (0.5 phr), zinc stearate (0.5 phr), diphenyl guanidine (DPG, 0.2 phr) and N-cyclohexyl-2-benzothiazole sulfonamide (CBS, 0.2 phr) and vulcanized for 2 hours at 150° C. FIG. 3(a) showed that the incorporation of the DBDCP in uncured polypentenamer produced elastomeric behavior (i.e., CPR-V1 and CPR-V2), and the tensile strength increased with level of DBDCP incorporated. FIG. 4 showed that the CPR homopolymer and the vitrimers could be vulcanized with sulfur at 150° C. The final elastic modulus (G′) of the vulcanized samples was an increasing function of the DBDCP level in the copolymers. As shown in FIG. 3(b), vulcanization of the three samples enhanced their elastomeric behavior. The tensile strength was higher in the vitrimers, compared to the CPR homopolymer. The data of tensile stress at strain=1000% of the unvulcanized samples and vulcanized samples were summarized in table 3.

TABLE 3

| | | Tensile stress at | Tensile stress at |
|---|---|---|---|
| | | strain = 1000% | strain = 1000% |
| | | (unvulcanized | (vulcanized |
| Example | Name | samples) (kPa) | samples) (MPa) |
| | CPR | 3.28 | 3.26 |
| 2 | CPR-V1 | 187 | 4.00 |
| 3 | CPR-V2 | 968 | 4.20 |

Cure kinetics curves of CPR homopolymer and the vitrimers CPR-V1 and CPR-V2 measured at 150° C. were shown in FIG. 4. All samples contained sulfur (0.5 phr), zinc stearate (0.5 phr), diphenyl guanidine (DPG, 0.2 phr) and N-cyclohexyl-2-benzothiazole sulfonamide (CBS, 0.2 phr) in addition to 100 phr CPR, CPR-V1 or CPR-V2.

### OTHER EMBODIMENTS

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

1. A vitrimer of cyclopentene-based ring-opening polyolefin, wherein the cyclopentene-based ring-opening polyolefin is crosslinked with a compound (1), wherein compound (1) contains at least one reversible borate moiety or derivative thereof and at least two cyclic olefin groups; and there is a reversible borate moiety or derivative thereof between any two cyclic olefin groups in compound (1);
wherein the derivative of borate moiety represents a moiety with the oxygen in the borate moiety being replaced with other element of the sixth main group, for example sulfur.

2. The vitrimer according to claim 1, wherein the reversible borate moiety or derivative thereof has a structure of Formula (I): 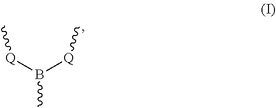
wherein each Q is independently an element of the sixth main group, or oxygen or sulfur.

3. The vitrimer according to claim 2, wherein the -Q-B-Q- moiety in Formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring to form a fused ring system; or two -Q-B-Q- moieties share one B atom and form a spiro ring.

4. The vitrimer according to claim 3, wherein the boron-containing ring has the following structure: 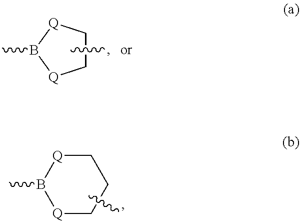
the fused ring system containing the boron-containing ring has the following structure: 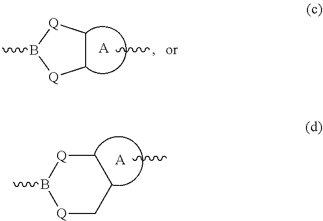
or two -Q-B-Q- moieties share one B atom and form a spiro ring;
wherein A is a ring having 5 to 10 ring members and wherein each Q is independently an element of the sixth main group, or oxygen or sulfur.

5. The vitrimer according to claim 1, wherein compound (1) contains 1 to 3 reversible borate moieties or derivative thereof and 2 to 4 cyclic olefin groups; or compound (1) contains 1 or 2 reversible borate moieties or derivative thereof and 2 or 3 cyclic olefin groups.

6. The vitrimer according to claim 1, wherein compound (1) is selected from at least one compound having following structure: 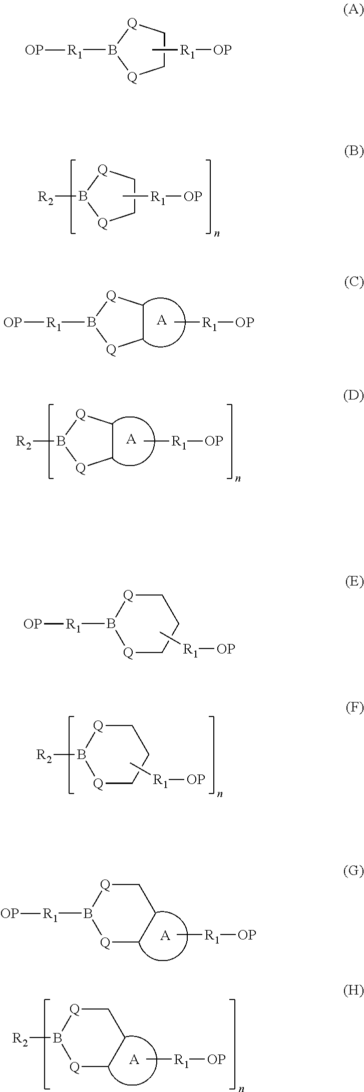
wherein:
each R₁ is independently a direct bond or a divalent organic group having 1 to 20 carbon atoms;
each R₂ is independently a direct bond or an organic group having 1 to 20 carbon atoms; or two -Q-B-Q- moieties share one B atom and form a spiro ring;
OP is a cyclic olefin group;
each A is independently a ring having 5 to 10 ring members;
each Q is independently an element of the sixth main group, or oxygen or sulfur; and
n is 2, 3 or 4.

7. The vitrimer according to claim 6, wherein the variables in the compounds of Formulae (A) to (H) have the following definitions:
each R₁ is independently a direct bond or a divalent hydrocarbyl having 1 to 12 carbon atoms, which can optionally be interrupted by one or more nonadjacent oxygen atoms, and/or one or more nonadjacent carbon atoms in the divalent hydrocarbyl can optionally be replaced with —(CO)—O— and/or CO;
each R₂ is independently a direct bond or a linear or branched hydrocarbyl having 1 to 12 carbon atoms; or C₄-C₈-cycloalkyl, C₅-C₁₀-cycloalkenyl, C₆-C₁₀ aryl, C₁-C₁₂ alkyl-C₆-C₁₀ aryl, C₆-C₁₀ aryl-C₆-C₁₀ aryl, C₆-C₁₀ aryl-C₁-C₁₂ alkylene-C₆-C₁₀ aryl, C₄-C₁₀ heterocycloalkyl, C₄-C₁₀ heterocycloalkenyl, C₄-C₁₀ hetaryl or C₄-C₁₀ hetaryl-C₄-C₁₀ hetaryl, wherein the hydrocarbyl and the C₁-C₁₂ alkylene can optionally be interrupted by one or more nonadjacent oxygen atoms, and/or one or more nonadjacent carbon atoms in the hydrocarbyl and the C₁-C₁₂ alkylene can optionally be replaced with —(CO)—O— and/or CO and wherein the heterocycloalkyl, heterocycloalkenyl and hetaryl contain 1 to 3 heteroatoms selected from N, O, and S; and wherein the valence of R₂ corresponds to the value of n; or two -Q-B-Q- moieties share one B atom and form a spiro ring;
OP is a cyclic olefin group;
each A is independently a ring having 5 or 6 ring members;
each Q is oxygen; and
n is 2 or 3.

8. The vitrimer according to claim 6, wherein
each R₁ is independently a direct bond or C₁-C₁₂ alkylene, which can optionally be interrupted by one or more nonadjacent oxygen atoms, and/or one or more nonadjacent carbon atoms in the C₁-C₁₂ alkylene can optionally be replaced with —(CO)—O— and/or CO; and
each R₂ is independently a direct bond, divalent or trivalent C₁-C₁₂ alkyl, divalent or trivalent C₄-C₈-cycloalkyl, divalent or trivalent C₅-C₁₀-cycloalkenyl, divalent or trivalent C₆-C₁₀ aryl, divalent or trivalent C₁-C₁₂ alkyl-C₆-C₁₀ aryl, divalent or trivalent C₆-C₁₀ aryl-C₆-C₁₀ aryl, divalent or trivalent C₆-C₁₀ aryl-C₁-C₁₂ alkylene-C₆-C₁₀ aryl, divalent or trivalent C₄-C₁₀ heterocycloalkyl, divalent or trivalent C₄-C₁₀ heterocycloalkenyl, divalent or trivalent C₄-C₁₀ hetaryl, divalent or trivalent C₄-C₁₀ hetaryl-C₄-C₁₀ hetaryl, wherein the heterocycloalkyl, heterocycloalkenyl and hetaryl contain 1 to 3 heteroatoms selected from N, O, and S, wherein the divalent or trivalent C₁-C₁₂ alkyl and C₁-C₁₂ alkylene can optionally be interrupted by one or more nonadjacent oxygen atoms, and/or one or more nonadjacent carbon atoms in the divalent or trivalent C₁-C₁₂ alkyl and the C₁-C₁₂ alkylene can optionally be replaced with —(CO)—O— and/or CO.

9. The vitrimer according to claim 1, wherein the cyclic olefin group in the compound (1) is selected from 1-hydroxy-4-cyclooctene, 1-acetoxy-4-cyclooctene, cyclopentene, 5-methylcyclopentene, dicyclopentadiene (DCPD), norbornene, norbornadiene, cycloheptene, cyclooctene, cyclooctadiene, cyclododecene, 7-oxanorbornene, 7-oxanorbornadiene, cis-5-norbornene-endo-2,3-dicarboxylic anhydride, dimethyl norbornene carboxylate, and norbornene-exo-2,3-carboxylic anhydride groups, preferably cyclopentene group.

10. The vitrimer according to claim 1, wherein compound (1) is (1,4-phenylenebis(1,3,2-dioxaborolane-2,4-diyl))bis(butane-4,1-diyl)bis(cyclopent-3-ene-1-carboxylate).

11. The vitrimer according to claim 1, wherein the molar amount of the moiety derived from compound (1) is in the range from about 0.5 mol % to about 15 mol %, or from about 0.6 mol % to about 10 mol %, based on the total molar amount of the repeat unit of the cyclopentene-based ring-opening polyolefin.

12. The vitrimer according to claim 1, wherein the vitrimer is formed from cyclopentene and compound (1), or the vitrimer is formed from cyclopentene, compound (1) and other comonomer.

13. The vitrimer according to claim 1, wherein the tensile stress at 1000% strain of the vitrimer is at least 30 times, or at least 40 times that of the neat cyclopentene-based ring-opening polyolefin.

14. The vitrimer according to claim 1, wherein the elastic modulus of the vitrimer is at least about 180% or at least about 250% of the elastic modulus of the neat cyclopentene-based ring-opening polyolefin, at 150° C. tested by dynamic thermal-mechanical analysis at a heating rate of 2° C./min.

15. (canceled)

16. A compound comprising: (1) the vitrimer as defined in claim 1, wherein the compound contains at least one reversible borate moiety or derivative thereof and at least two cyclic olefin groups; and there is a reversible borate moiety or derivative thereof between any two cyclic olefin groups in the compound;
wherein the derivative of borate moiety represents a moiety with the oxygen in the borate moiety being replaced with other element of the sixth main group, for example sulfur.

17. (canceled)

18. A vulcanized vitrimer, which is formed by vulcanizing the vitrimer as defined in claim 1.

19. The vulcanized vitrimer according to claim 18, wherein the tensile stress at 1000% strain of the vulcanized vitrimer is at least about 110%, or at least about 120% of the tensile stress at 1000% strain of the vulcanized neat cyclopentene-based ring-opening polyolefin.

20. (canceled)

21. (canceled)
